(19) United States
(12) Patent Application Publication
(10) Pub. No.: US 2013/0073253 A1
(43) Pub. Date: Mar. 21, 2013

(54) STATE ESTIMATION APPARATUS AND OFFSET UPDATE METHOD

(71) Applicant: IBUKI HANDA, Hamamatsu-shi (JP)

(72) Inventor: IBUKI HANDA, Hamamatsu-shi (JP)

(73) Assignee: Yamaha Corporation, Hamamatsu-Shi (JP)

(21) Appl. No.: 13/613,885

(22) Filed: Sep. 13, 2012

(30) Foreign Application Priority Data
Sep. 20, 2011 (JP) 2011-204681

(51) Int. Cl. G01B 7/28; G06F 15/00

(52) U.S. Cl. 702/152

(57) ABSTRACT

A state estimation apparatus has a plurality of sensors including a three-dimensional magnetic sensor for detecting magnetic components. A Kalman filter is used to update a state vector based on an observation residual. The state vector has components representing a plurality of state variables which include a state variable for estimating an offset of the magnetic data. A central point calculation unit assumes that coordinates indicated by a predetermined number of the magnetic data probabilistically distribute in the vicinity of a spherical surface, and calculates a central point of the spherical surface. The Kalman filter updates the state variable for estimating an offset of the magnetic data using the central point of the spherical surface.

### BACKGROUND OF THE INVENTION

1. Technical Field of the Invention

The present invention relates to a state estimation apparatus and an offset update method.

2. Description of the Related Art

In recent years, portable instruments having a function for estimating the direction of geomagnetism and the posture of the portable instrument have been actively researched and developed with the increase in performance and purpose of portable instruments. In a case in which the direction of the geomagnetism and the posture of the portable instrument are estimated, estimation using integration of outputs from a plurality of sensors for measuring different kinds of physical quantities is achieved at higher speed than estimation using only output from a single sensor, such as a geomagnetic sensor.

A method using a Kalman filter is well known as a method of integrating outputs from a plurality of sensors for measuring different kinds of physical quantities to estimate the state of a dynamic system. For example, patent literature 1 discloses a posture angle measuring apparatus having a three axis angular velocity sensor, a three axis acceleration sensor, and a nonlinear Kalman filter mounted therein. Also, non-patent literature 1 discloses a method of integrating signals output from a three axis angular velocity sensor, a three axis acceleration sensor, and a three axis geomagnetic sensor using an extended Kalman filter or a sigma point Kalman filter using unscented transformation.
[Patent Literature 1] Japanese Patent Application Publication No. H9-5104
[Non-Patent Literature 1] Wolfgang Gunthner, “Enhancing Cognitive Assistance Systems with Inertial Measurement Units”, Springer, 2008

Generally, a Kalman filter has a state transition model for estimating time-based change of a plurality of physical quantities representing the state of a dynamic system and an observation model for estimating an observed value measured by a plurality of sensors of the dynamic system from the estimated state of the dynamic system. Also, the Kalman filter updates a state vector having physical quantities representing the state of the dynamic system as elements to a value more approximate to a real value using a difference (observation residual) between the estimated observed value and an observed value actually measured by the sensors.

However, the observation residual is a value calculated by a state vector before update. In a case in which the state of the dynamic system is abruptly and significantly changed, the state vector may be updated to a false value different from the real value.

### SUMMARY OF THE INVENTION

The present invention has been made in view of the above problem, and it is an object of the present invention to correctly estimate the state of a dynamic system even in a case in which the state of the dynamic system is suddenly and greatly changed.

Hereinafter, the present invention will be described. Meanwhile, reference symbols of embodiments, modifications, and the accompanying drawings are shown in parentheses for ease of understanding, by which, however, the present invention is not limited to the embodiments.

In order to solve the above problems, a state estimation apparatus according to the present invention comprises:

a plurality of sensors including a three-dimensional magnetic sensor configured to detect magnetic components in three directions and configured to sequentially output magnetic data (qᵢ) representing the detected magnetic components; a Kalman filter configured to update a state vector (xₖ) based on an observation residual (zₖ), the state vector having components representing a plurality of state variables which include a state variable (qₒ) estimating an offset (q_{OFF}) of the magnetic data, the observation residual being calculated using the state vector and an observation vector (yₖ) having components representing outputs of the plurality of sensors; an accumulation unit configured to accumulate the magnetic data sequentially output from the three dimensional magnetic sensor; and a central point calculation unit configured to assume that coordinates indicated by a predetermined number (N) of the accumulated magnetic data probabilistically distribute in the vicinity of a first spherical surface (S), and configured to calculate coordinates indicating a central point (cₒ) of the first spherical surface, wherein the Kalman filter updates or overwrites the state variable (qₒ) estimating an offset (q_{OFF}) of the magnetic data using the coordinates indicating the central point (cₒ) of the first spherical surface.

Expediently, the three-dimensional magnetic sensor is mounted in an instrument comprising a part generating a magnetic field (Bᵢ). In such a case, the offset (q_{OFF}) is a three-dimensional vector representing a component of the magnetic field (Bᵢ) generated by the part of the instrument.

According to the present invention, the state estimation apparatus, including the central point calculation unit and the Kalman filter, updates or overwrites the state variable for estimating the offset of the three-dimensional magnetic sensor, which is one of the components of the state vector used in Kalman filter operation, using the coordinates of the central point calculated by the central point calculation unit and, performs the Kalman filter operation.

The Kalman filter performs operation of updating a state vector having its components physical quantities (state variables) representing the state of a dynamic system at a certain time based on an observation residual calculated using an observation vector having its components output values from a plurality of sensors for measuring different kinds of physical quantities and the state vector so that the state vector approximates to a real value of the dynamic system.

Specifically, the Kalman filter estimates the state vector after the lapse of a unit time from the state vector at a certain time using a state transition model representing time-based change in the state of the dynamic system. Subsequently, the Kalman filter estimates an observation vector from the estimated state vector using an observation model for estimating output values from the sensors from the estimated value of the state of the dynamic system. Furthermore, the Kalman filter calculates the difference between the estimated observation vector and an observation vector having as its components real outputs from various kinds of sensors (real observed values) to calculate the observation residual. Also, the Kalman filter updates the state vector using the observation residual.

Meanwhile, an instrument having a three-dimensional magnetic sensor mounted therein often includes a mechanical or electronic part generating a magnetic field, such as various kinds of metal that can be magnetized and electric circuits. In this case, vector data output by the three-dimensional magnetic sensor also include a vector representing a magnetic field generated by the part mounted in the instrument in addition to a vector representing target geomagnetism. In order to correctly detect a value of geomagnetism, therefore, it is necessary to perform a correction process for removing a vector representing an internal magnetic field generated by the part of the instrument from the vector data output by the three-dimensional magnetic sensor. A vector representing the internal magnetic field removed from the data output from the three-dimensional magnetic sensor to obtain a correct value of geomagnetism to be detected in the correction process is referred to as an offset of the three-dimensional magnetic sensor.

In a case in which the internal state of the instrument is not changed, the internal magnetic field has a uniform direction and magnitude. On the other hand, in a case in which the internal state of the instrument is changed, the direction and magnitude of the internal magnetic field are changed. The internal state of the instrument may be suddenly and greatly changed depending upon user manipulation of the instrument, external environment of the instrument, etc. Consequently, the internal magnetic field generated by the part of the instrument (that is, offset of the three-dimensional magnetic sensor) is also suddenly and greatly changed as the internal state of the instrument is changed.

As previously described, the Kalman filter operation includes an operation of estimating a value of the state vector after the lapse of a unit time from a value of the state vector at a certain time using the state transition model representing time-based change in the state of the dynamic system. Preferably, therefore, the state variable estimated by the Kalman filter be a physical quantity that can be formalized in the state transition model. Since the offset of the three-dimensional magnetic sensor is abruptly and drastically changed by user manipulation of the instrument, however, it is difficult to formalize the change of the offset value.

Also, the observation residual used to update the state vector is calculated based on a value of the state vector before update. That is, a value of the updated state vector calculated through the Kalman filter operation is affected by the value of the previous state vector before update. Further, the value of the previous state vector before update is affected by a value of the past state vector further before the update. In a case in which the Kalman filter operation is repeated, therefore, the value of the state vector estimated by the Kalman filter is calculated in consideration of values of the state vector at all steps ranging from time when the Kalman filter operation is commenced to time when the value of the state vector is estimated. In a case in which the offset of the three-dimensional magnetic sensor is suddenly and greatly changed, therefore, the value of the state variable after update estimating the offset of the three-dimensional magnetic sensor may greatly deviate from the offset of the three-dimensional magnetic sensor after change.

In a case in which the value of the state vector converges to a value greatly deviating from a value correctly indicating a real physical quantity (real value), the value of the state vector may not approximate to the real value although the Kalman filter operation is repeated afterward. Also, even if the value of the state vector approximates to the real value, it takes a long time until the value of the state vector converges to the real value. In this case, it is not possible for the state estimation apparatus to correctly estimate the state of the system, and therefore, it is not possible to calculate the direction of the geomagnetism and the posture of the instrument based on the state variables calculated by the state estimation apparatus.

The geomagnetism is a kind of magnetic field having a horizontal component directed to a north magnetic pole of Earth and a component perpendicular to a magnetic dip direction. The geomagnetism is a uniform magnetic field having a uniform direction and uniform magnitude with respect to the ground. In a case in which the posture of the instrument is changed with respect to the ground, therefore, the direction of the geomagnetism viewed from the instrument is also changed. That is, when viewed from the three-dimensional magnetic sensor mounted in the instrument, the geomagnetism is represented as a vector having a direction changed as the posture of the instrument is changed and having uniform magnitude.

On the other hand, in a case in which the internal state of the instrument is not changed, the internal magnetic field has a uniform direction with respect to the instrument and has uniform magnitude. In a case in which the internal state of the instrument is not changed, therefore, the internal magnetic field is represented as a vector having a uniform direction and uniform magnitude even in a case in which the posture of the instrument is changed when viewed from the three-dimensional magnetic sensor mounted in the instrument.

Consequently, a plurality of magnetic data acquired while changing the posture of the three-dimensional magnetic sensor are distributed in the vicinity of a spherical surface having a center identified by the front end of a vector representing the direction and magnitude of the internal magnetic field and having a radius corresponding to the magnitude of the geomagnetism.

On the assumption that coordinates indicated by a plurality of magnetic data are probabilistically distributed in the vicinity of a certain spherical surface (first spherical surface), the central point calculation unit calculates coordinates of a central point of the first spherical surface to calculate the internal magnetic field, i.e. the offset of the three-dimensional magnetic sensor. Even in a case in which the offset of the three-dimensional magnetic sensor is suddenly and greatly changed, it is possible for the central point calculation unit to calculate a correct offset using a plurality of magnetic data acquired afterward.

In the state estimation apparatus according to the present invention, the state variable for estimating the offset of the three-dimensional magnetic sensor, which is one of the components constituting the state vector, is overwritten using the central point output by the central point calculation unit.

Even in a case in which the offset of the three-dimensional magnetic sensor is suddenly and greatly changed, therefore, it is possible for the central point calculation unit to calculate the coordinates of the central point representing the offset after change and to overwrite the state variable for estimating the offset of the three-dimensional magnetic sensor using the coordinates of the central point. Consequently, it is possible to prevent the state variable for estimating the offset of the three-dimensional magnetic sensor from deviating from the real value (offset of the three-dimensional magnetic sensor) for a long period of time. That is, the state estimation apparatus according to the present invention correctly estimates the state of the system, and therefore, it is possible to calculate a correct direction of the geomagnetism and a correct posture of the instrument based on the state variables calculated by the state estimation apparatus.

In a practical form, the Kalman filter is configured to use a state transition model (f) for estimating a state vector (x⁻ₖ) after lapse of a unit time from a state vector (xₖ₋₁) at a certain time, configured to use an observation model (h) for calculating an estimated observation vector (y⁻ₖ) from the estimated state vector (x⁻ₖ) after the lapse of the unit time, configured to calculate an observation residual (zₖ) based on the estimated observation vector (y⁻ₖ) and the observation vector (yₖ) having components representing outputs of the plurality of sensors, and configured to update the state vector (xₖ) based on the observation residual (zₖ) and the estimated state vector (x⁻ₖ) after the lapse of the unit time.

The state estimation apparatus further comprises: a distribution decision unit configured to calculate a dispersion evaluation value indicating a degree of three-dimensional dispersion in distribution of coordinates of the predetermined number (N) of the accumulated magnetic data, so that the central point calculation unit is configured to calculate the coordinates indicating the central point (cₒ) of the first spherical surface (S) in case that the dispersion evaluation value is equal to or greater than an allowable dispersion value (λₒ); a distortion decision unit configured to assume that the coordinates indicated by a plurality of the accumulated magnetic data are probabilistically distribute in the vicinity of a surface of a three-dimensional figure (SD) obtained by combining a second spherical surface (S₂) and a curved surface (SX), configured to calculate a distortion evaluation value (g_{D}(E)) indicating a degree of difference of a shape of the three-dimensional figure from a shape of the second spherical surface based on the plurality of the accumulated magnetic data, and configured to decide whether or not the distortion evaluation value is equal to or less than an allowable distortion value (δₒ); and a central point output unit configured to output the coordinates indicating the central point of the first spherical surface in case that a decision result of the distortion decision unit is affirmative.

In such a case, the Kalman filter is configured to update the state variable for estimating an offset using the coordinates indicating the central point of the first spherical surface in case that the central point output unit outputs the coordinates indicating the central point of the first spherical surface.

As previously described, the central point calculation unit calculates the coordinates of the central point of the first spherical surface on the assumption that the coordinates indicated by the magnetic data are distributed in the vicinity of the first spherical surface. In a case in which the magnetic data have a planar distribution without three-dimensional extension, therefore, it is not possible to correctly specify the coordinates of the central point of the first spherical surface.

According to the present invention, first, the distribution decision unit calculates a dispersion evaluation value indicating a degree of three-dimensional extension of the magnetic data, and, in a case in which the dispersion evaluation value is equal to or greater than an allowable dispersion value, the central point calculation unit calculates the coordinates of the central point. In a case in which the magnetic data are two-dimensionally distributed, therefore, it is possible to prevent the central point calculation unit from calculating coordinates of an incorrect central point.

Consequently, it is possible to prevent calculation of an incorrect direction and magnitude of geomagnetism through a correction process using an incorrect offset. Also, since it is possible to prevent an operation process of calculating the coordinates of the incorrect central point from being performed, it is possible to achieve low power consumption of the state estimation apparatus.

Also, according to the present invention, the distortion decision unit decides to what extent the shape of the three-dimensional figure having the coordinates of the magnetic data in the vicinity of the surface thereof is different from the shape of the second spherical surface based on the distortion evaluation value.

In a case in which the distortion evaluation value is greater than the threshold value, the three-dimensional figure has a distorted shape different from that of the second spherical surface. Consequently, the coordinates indicated by the magnetic data in the vicinity of the surface of the three-dimensional figure cannot be regarded as being distributed in the vicinity of the first spherical surface. Since the central point calculation unit calculates the coordinates of the central point, which is a candidate of the offset of the three-dimensional magnetic sensor, on the premise that the magnetic data are present in the vicinity of the first spherical surface, the vector indicating the coordinates of the central point of the first spherical surface not having the magnetic data in the vicinity thereof does not mean the offset of the three-dimensional magnetic sensor. Since the state estimation apparatus according to the present invention includes the distortion decision unit, it is possible to prevent the state variable for estimating the offset of the three-dimensional magnetic sensor from being overwritten using a vector indicating coordinates of an improper central point that cannot be regarded as the offset of the three-dimensional magnetic sensor.

As described above, the state estimation apparatus according to the present invention includes the distribution decision unit and the distortion decision unit. Only in a case in which the coordinates of the central point approximate to a real value that can be regarded as the offset of the three-dimensional magnetic sensor are obtained, therefore, the state estimation apparatus overwrites the state variable for estimating the offset of the three-dimensional magnetic sensor using a vector indicating the coordinates of the central point approximate to the real value. Consequently, it is possible for the state estimation apparatus according to the present invention to correctly estimate the state of the system, and therefore, it is possible to calculate a correct direction of the geomagnetism and a correct posture of the instrument based on the state variables calculated by the state estimation apparatus.

Also, as a concrete embodiment of the present invention, the state estimation apparatus may include a unit for urging a user to change the posture of the instrument without changing the position of the instrument in a case in which the decision result of the distortion decision unit is negative.

According to the present invention, in a case in which the distortion decision unit decides that the distortion evaluation value is greater than the allowable distortion value, i.e. in a case in which the shape of the three-dimensional figure has great distortion from the spherical surface when the coordinates indicated by the magnetic data output from the three-dimensional magnetic sensor are distributed in the vicinity of the surface of the three-dimensional figure, the state estimation apparatus includes a unit for urging a user to change the posture of the instrument without changing the position of the instrument.

The three-dimensional magnetic sensor may detect an internal magnetic field generated by a mechanical or electronic part of the instrument and a nonuniform external magnetic field generated by an object present outside the instrument in addition to geomagnetism to be measured. In a case in which the influence of the nonuniform external magnetic field is great, the coordinates indicated by the magnetic data are distributed in the vicinity of the surface of the three-dimensional figure having a distorted shape greatly different from the spherical surface with the result that it is not possible to adopt the vector indicating the coordinates of the central point calculated by the central point calculation unit as the offset of the three-dimensional magnetic sensor.

In a case in which the relative positional relationship between the object outside the instrument generating the external magnetic field and the three-dimensional magnetic sensor is not changed, however, the nonuniform external magnetic field is merely a magnetic field having uniform magnitude. That is, in a case in which the posture of the three-dimensional magnetic sensor is changed in a state in which the position of the three-dimensional magnetic sensor is fixed, the external magnetic field is detected as a uniform magnetic field, the magnitude of which is uniform and only the direction of which is changed, by the three-dimensional magnetic sensor. In this case, the coordinates indicated by the magnetic data output from the three-dimensional magnetic sensor are distributed in the vicinity of a certain spherical surface. Also, coordinates of a central point of this spherical surface are almost the same as coordinates indicated by a vector representing a magnetic field (internal magnetic field) component generated by the part of the instrument.

As previously described, the first spherical surface is set on the assumption that the coordinates indicated by the magnetic data are distributed in the vicinity of the first spherical surface. In a case in which the coordinates indicated by the magnetic data are distributed so as to have the shape of a spherical surface, therefore, the coordinates indicated by the magnetic data can be regarded as also being distributed in the vicinity of the first spherical surface having the central point calculated by the central point calculation unit as the center. Consequently, the coordinates of the central point of the first spherical surface are almost the same as the coordinates indicated by the vector representing the internal magnetic field component, and therefore, it is possible to adopt the vector indicating the coordinates of the central point of the first spherical surface as the offset of the three-dimensional magnetic sensor.

As described above, the state estimation apparatus includes the unit for urging a user to change the posture of the instrument without changing the position of the instrument, and therefore, it is possible to urge the user to perform an operation of calculating a proper offset even at a place at which a nonuniform external magnetic field is present.

Also, as a concrete embodiment of the present invention, in the state estimation apparatus, the dispersion evaluation value may be set to a minimum eigenvalue (λ₃) of a variance-covariance matrix (A) representing dispersion of the three axis coordinates indicated by the magnetic data.

According to the present invention, the minimum eigenvalue of the variance-covariance matrix representing dispersion of the magnetic data is used as the dispersion evaluation value.

Since the magnetic data indicate the three axis coordinates, the variance-covariance matrix representing dispersion of the magnetic data is a matrix of 3×3. Three eigenvectors and three eigenvalues are obtained from this variance-covariance matrix. One of the three eigenvectors represents a direction in which the magnetic data are most greatly distributed. An eigenvalue corresponding to this eigenvector becomes a maximum eigenvalue. On the other hand, an eigenvalue corresponding to an eigenvector representing a direction in which the magnetic data are least distributed becomes a minimum eigenvalue. In a case in which the magnetic data are ideally two-dimensionally distributed, the minimum eigenvalue has a value infinitely approximate to zero. In a case in which the magnetic data are three-dimensionally distributed, the minimum eigenvalue has a great value according to a degree of three-dimensional dispersion in distribution of the magnetic data. Consequently, the minimum eigenvalue of the variance-covariance matrix is used as the dispersion evaluation value, and therefore, it is possible to correctly grasp a degree of three-dimensional dispersion in distribution of the magnetic data.

Also, as a concrete embodiment of the present invention, in the state estimation apparatus, when the inner product of a three axis vector (qᵢ-cₒ) representing the magnetic data in a coordinate system having the central point of the first spherical surface as the origin and a vector (E(qᵢ-cₒ)) obtained by converting the three axis vector using a distortion evaluation matrix (E), which is a symmetric matrix, is calculated with respect to each of the magnetic data, a vector having the calculation results as its components is set as a distortion error vector (k(E)), a vector representing errors between positions specified by the three axis coordinates indicated by the magnetic data and the second spherical surface (S₂) is set as a second spherical error vector (δ_{S2}), the sum of the distortion error vector and the second spherical error vector is set as a solid error vector (δ_{SD}). When a function representing the magnitude of the solid error vector is set as a distortion evaluation function (f_{SD}(E, c)) while components (e₁₁ to e₃₃) of the distortion evaluation matrix (E) and three axis coordinates indicating a central point (c_{O2}) of the second spherical surface are set as variables, the distortion evaluation value may be norm of the distortion evaluation matrix when the distortion evaluation function is minimized.

According to the present invention, the magnitude of the solid error vector is minimized to calculate the distortion evaluation matrix and the coordinates of the central point of the second spherical surface. Also, the distortion evaluation value is calculated as the norm of the distortion evaluation matrix. Since the distortion evaluation matrix is a symmetric matrix for converting the coordinates of the three axis vector, the distortion evaluation matrix is a matrix of 3×3. Consequently, the distortion evaluation value has three eigenvalues, and an absolute value of the eigenvalue having the maximum absolute value, which is one of the three eigenvalues, becomes the distortion evaluation value.

The solid error vector is given as the sum of the second spherical error vector and the distortion error vector. The second spherical error vector is just a vector representing errors between the coordinates indicated by the magnetic data and the second spherical surface. In a case in which the second spherical surface is set so as to minimize errors between the coordinates indicated by the magnetic data and the second spherical surface, all of the errors indicated by the spherical error vector become white noise which is symmetric and is not dependent on direction.

On the other hand, the distortion error vector is a vector obtained by arranging the inner product of a vector indicating the coordinates indicated by the magnetic data viewed from the central point of the first spherical surface and a vector obtained by converting the vector indicating the coordinates indicated by the magnetic data using the distortion evaluation matrix with respect to each of the magnetic data. In other words, each component of the distortion error vector is configured in a three-variable quadratic form having the distortion evaluation matrix, which is a symmetric matrix, as a coefficient matrix and having each of the three components of the vector representing the coordinates of the magnetic data viewed from the central point as a variable. That is, the distortion error vector is a vector expressing each of the errors between the coordinates indicated by the magnetic data and the second spherical surface under the restriction that the errors between the coordinates indicated by the magnetic data and the second spherical surface are present on a curved surface based on the same function represented in a quadratic form. It is possible to express errors (that is, distortion from a spherical surface) represented by a curved surface based on a quadratic function, aside from the white noise, by expressing the errors between the magnetic data and the second spherical surface using the distortion error vector.

The solid error vector is obtained by adding the spherical error vector to the distortion error vector expressing a three-dimensional figure which has a plurality of magnetic data in the vicinity of the surface thereof. Namely, the three-dimensional figure is represented by overlapping a spherical surface and a curved surface, and is different from the spherical surface. Also, the magnitude of the distortion error vector in the solid error vector can be evaluated by determining to what extent the shape of the three-dimensional figure is different (distorted) from that of the second spherical surface (that is, the magnitude of an error due to distortion from a surface different from white noise). As a result, in a case in which it is evaluated that the three-dimensional figure and the second spherical surface are approximate to each other to such an extent that the three-dimensional figure and the second spherical surface have substantially the same shape, the coordinates indicated by the magnetic data can be regarded as also being distributed in the vicinity of the second spherical surface. As previously described, in a case in which the coordinates indicated by the magnetic data are distributed so as to have the shape of a spherical surface, it is possible to regard the coordinates indicated by the magnetic data as also being distributed in the vicinity of the first spherical surface. In a case in which it is evaluated that the three-dimensional figure and the second spherical surface are approximate to each other to such an extent that the three-dimensional figure and the second spherical surface have substantially the same shape, therefore, it is possible to adopt the vector indicating the coordinates of the central point of the first spherical surface as the offset of the three-dimensional magnetic sensor. On the other hand, in a case in which it is evaluated that the three-dimensional figure has a distorted shape greatly different from that of the second spherical surface, the coordinates indicated by the magnetic data cannot be regarded as being distributed in the vicinity of the second spherical surface, and therefore, it is necessary to prevent the vector indicating the coordinates of the central point of the first spherical surface from being adopted as the offset of the three-dimensional magnetic sensor.

That is, it is possible for the state estimation apparatus to adopt only a vector indicating coordinates of a proper central point, calculated by a plurality of magnetic data which is not affected by the nonuniform external magnetic field, among the coordinates of the central point calculated by the central point calculation unit, as the offset of the three-dimensional magnetic sensor. As a result, the state estimation apparatus correctly estimates the state of the system, and therefore, it is possible to calculate a correct direction of the geomagnetism and a correct posture of the instrument based on the state variables calculated by the state estimation apparatus.

Also, in the above-described state estimation apparatus, the central point calculation unit is configured to assume that positions specified by the coordinates indicated by the magnetic data probabilistically distribute in the vicinity of the first spherical surface, configured to set first spherical error vectors (δ_{S}) representing errors between the positions specified by the coordinates indicated by the magnetic data and the first spherical surface, configured to set a central point calculation function (f_{S}(c)) which contains a three-dimensional vector (c) as a variable, and which represents a magnitude of the first spherical error vectors (δ_{S}), and configured to calculate the coordinates indicating the central point of the first spherical surface as coordinates indicated by the three-dimensional vector when a value of the central point calculation function is minimized.

According to the present invention, it is possible to calculate the coordinates becoming a candidate of the offset of the three-dimensional magnetic sensor through simple calculation.

Also, as a concrete embodiment of the present invention, in the state estimation apparatus, the distortion evaluation function can be represented by the following f_{SD}(E, c).

f_{SD}(E,c)=∥δ_{SD}∥₂

Where, N is a natural number equal to or greater than 5, and

when the three axis coordinates indicated by the respective magnetic data are denoted by qᵢ(i=1, . . . , N), the three axis coordinates indicating the central point of the first spherical surface are denoted by cₒ, which is a three-dimensional vector, the distortion evaluation matrix is set to a matrix of 3×3 denoted by the following E, the distortion error vector is represented by an N-dimensional vector denoted by the following k(E),

c is set as a three-dimensional vector having its components three variables for representing the central point of the second spherical surface, X is set as the following matrix of N×3, q_{C} is set as the following three-dimensional vector, R is set as the following value, j is set as the following N-dimensional vector, and the second spherical error vector is represented by an N-dimensional vector denoted by the following δ_{S2},

the solid error vector is an N-dimensional vector denoted by the following δ_{SD}.

$${δ}_{SD} = {δ}_{S 2} + k ( E )$$

$$k ( E ) = [ \begin{matrix}{( {q}_{1} - {c}_{0} )}^{T} E ( {q}_{1} - {c}_{0} ) \\ ⋮ \\ {( {q}_{N} - {c}_{0} )}^{T} E ( {q}_{N} - {c}_{0} )\end{matrix} ]$$

$$E = [ \begin{matrix}{e}_{11} & {e}_{12} & {e}_{13} \\ {e}_{12} & {e}_{22} & {e}_{23} \\ {e}_{13} & {e}_{23} & {e}_{33 }\end{matrix} ]$$

$${δ}_{S 2} = X ( c - {q}_{C} ) - j$$

$$X = [ \begin{matrix}{( {q}_{1} - {q}_{C} )}^{T} \\ ⋮ \\ {( {q}_{N} - {q}_{C} )}^{T}\end{matrix} ]$$

$$j = \frac{1}{2} [ \begin{matrix}{( {q}_{1} - {q}_{C} )}^{T} ( {q}_{1} - {q}_{C} ) - R \\ ⋮ \\ {( {q}_{N} - {q}_{C} )}^{T} ( {q}_{N} - {q}_{C} ) - R\end{matrix} ]$$

$${q}_{C} = \frac{1}{N} {\sum }_{i = 1}^{N} {q}_{i}$$

$$R = \frac{1}{N} {\sum }_{i = 1}^{N} {( {q}_{i} - {q}_{C} )}^{T} ( {q}_{i} - {q}_{C} )$$

According to the present invention, it is possible to calculate the distortion evaluation value, which is the norm of the distortion evaluation matrix when the distortion evaluation function is minimized, through simple calculation. Consequently, the above-described state estimation apparatus has advantages in that it is possible to increase processing speed and to achieve low power consumption.

Also, as a concrete embodiment of the present invention, in the state estimation apparatus, it is possible to denote the central point calculation function by the following f_{S}(c).

f_{S}(c)=∥δ_{S}∥₂

Where, N is a natural number equal to or greater than 5, and

when the three axis coordinates indicated by the respective magnetic data are denoted by qᵢ(i=1, . . . , N), c is set as a three-dimensional vector having its components three variables for representing the three axis coordinates indicating the central point of the first spherical surface, X is set as the following matrix of N×3, q_{C} is set as the following three-dimensional vector, R is set as the following value, and j is set as the following N-dimensional vector, the first spherical error vector is an N-dimensional vector denoted by the following δ_{S}.

$${δ}_{S} = X ( c - {q}_{C} ) - j$$

$$X = [ \begin{matrix}{( {q}_{1} - {q}_{C} )}^{T} \\ ⋮ \\ {( {q}_{N} - {q}_{C} )}^{T }\end{matrix} ]$$

$${q}_{C} = \frac{1}{N} {\sum }_{i = 1}^{N} {q}_{i}$$

$$j = \frac{1}{2} [ \begin{matrix}{( {q}_{1} - {q}_{C} )}^{T} ( {q}_{1} - {q}_{C} ) - R \\ ⋮ \\ {( {q}_{N} - {q}_{C} )}^{T} ( {q}_{N} - {q}_{C} ) - R\end{matrix} ]$$

$$R = \frac{1}{N} {\sum }_{i = 1}^{N} {( {q}_{i} - {q}_{C} )}^{T} ( {q}_{i} - {q}_{C} )$$

According to the present invention, it is possible to calculate the central point through simple calculation. Consequently, the above-described state estimation apparatus has advantages in that it is possible to increase processing speed and to achieve low power consumption.

Also, the present invention provides an offset update method performed in a state estimation apparatus comprising a plurality of sensors including a three-dimensional magnetic sensor configured to detect magnetic components in three directions and configured to sequentially output magnetic data representing the detected magnetic components, the offset update method comprising; updating a state vector based on an observation residual, the state vector having components representing a plurality of state variables which include a state variable for estimating an offset of the magnetic data, the observation residue being calculated using the state vector and an observation vector having components representing outputs of the plurality of sensors; accumulating the magnetic data sequentially output from the three dimensional magnetic sensor; assuming that coordinates indicated by a predetermined number of the accumulated magnetic data probabilistically distribute in the vicinity of a first spherical surface; calculating coordinates indicating a central point of the first spherical surface; and updating the state variable for estimating an offset of the magnetic data using the coordinates indicating the central point of the first spherical surface.

According to the present invention, the state variable for estimating the offset of the three-dimensional magnetic sensor, which is one of the components constituting the state vector, is overwritten using the coordinates of the central point calculated based on the magnetic data. Even in a case in which the offset of the three-dimensional magnetic sensor is suddenly and greatly changed, it is possible to prevent the state variable for estimating the offset of the three-dimensional magnetic sensor from deviating from a real value (offset of the three-dimensional magnetic sensor). That is, the state estimation apparatus correctly estimates the state of the system, and therefore, it is possible to calculate a correct direction of the geomagnetism and a correct posture of the instrument based on the state variables calculated by the state estimation apparatus.

Also, the present invention provides an offset update program installed in a state estimation apparatus comprising a plurality of sensors including a three-dimensional magnetic sensor configured to detect magnetic components in three directions and configured to sequentially output magnetic data representing the detected magnetic components. The offset update program is executed by a computer in the state estimation apparatus to perform processing of; updating a state vector based on an observation residual, the state vector having components representing a plurality of state variables which include a state variable for estimating an offset of the magnetic data, the observation residue being calculated using the state vector and an observation vector having components representing outputs of the plurality of sensors; accumulating the magnetic data sequentially output from the three dimensional magnetic sensor; assuming that coordinates indicated by a predetermined number of the accumulated magnetic data probabilistically distribute in the vicinity of a first spherical surface; calculating coordinates indicating a central point of the first spherical surface; and updating the state variable for estimating an offset of the magnetic data using the coordinates indicating the central point of the first spherical surface.

According to the present invention, the state variable for estimating the offset of the three-dimensional magnetic sensor, which is one of the components constituting the state vector, is overwritten (updated, reset or initialized) using the coordinates of the central point calculated based on the magnetic data. Even in a case in which the offset of the three-dimensional magnetic sensor is abruptly and drastically changed, therefore, it is possible to prevent the state variable for estimating the offset of the three-dimensional magnetic sensor from deviating from a real value (offset of the three-dimensional magnetic sensor). That is, the state estimation apparatus correctly estimates the state of the system, and therefore, it is possible to calculate a correct direction of geomagnetism and a correct posture of the instrument based on the state variables calculated by the state estimation apparatus.

### BRIEF DESCRIPTION OF THE DRAWINGS

FIG. 1 is a block diagram showing the construction of a portable instrument according to an embodiment of the present invention.

FIG. 2 is a perspective view showing the external appearance of the portable instrument.

FIG. 3 is a conceptual view illustrating the outline of a magnetic field detected by a three-dimensional magnetic sensor according to an embodiment of the present invention.

FIG. 4 is a functional block diagram showing a function realized by executing a state estimation program according to an embodiment of the present invention.

FIG. 5 is a flow chart showing the operation of a state estimation unit according to an embodiment of the present invention.

FIG. 6 is a functional block diagram of a Kalman filter operation unit according to an embodiment of the present invention.

FIG. 7 is a flow chart showing the operation of a central point derivation unit according to an embodiment of the present invention.

FIG. 8 is a conceptual view illustrating geomagnetism and an internal magnetic field detected by the three-dimensional magnetic sensor according to the embodiment of the present invention.

FIG. 9 is a conceptual view illustrating a central point calculation process according to an embodiment of the present invention.

FIG. 10 is a conceptual view illustrating a case in which magnetic data detected by the three-dimensional magnetic sensor according to the embodiment of the present invention are two-dimensionally distributed.

FIG. 11 is a conceptual view illustrating a magnetic data distribution index calculation process according to an embodiment of the present invention.

FIG. 12 is a conceptual view illustrating geomagnetism, an internal magnetic field, and an external magnetic field detected by the three-dimensional magnetic sensor according to the embodiment of the present invention.

FIGS. 13(A) and 13(B) are conceptual views illustrating a distortion decision process according to an embodiment of the present invention.

FIG. 14 is a conceptual view illustrating a three-dimensional figure treated in the distortion decision process according to the embodiment of the present invention.

FIG. 15 is a conceptual view illustrating the distortion decision process according to the embodiment of the present invention.

FIG. 16 is a functional block diagram showing a function realized by executing a state estimation program according to a modification of the present invention.

### DETAILED DESCRIPTION OF THE INVENTION

### A. Embodiment

Hereinafter, an embodiment of the present invention will be described with reference to the accompanying drawings.

### 1. CONSTRUCTION OF INSTRUMENT AND CONSTRUCTION OF SOFTWARE

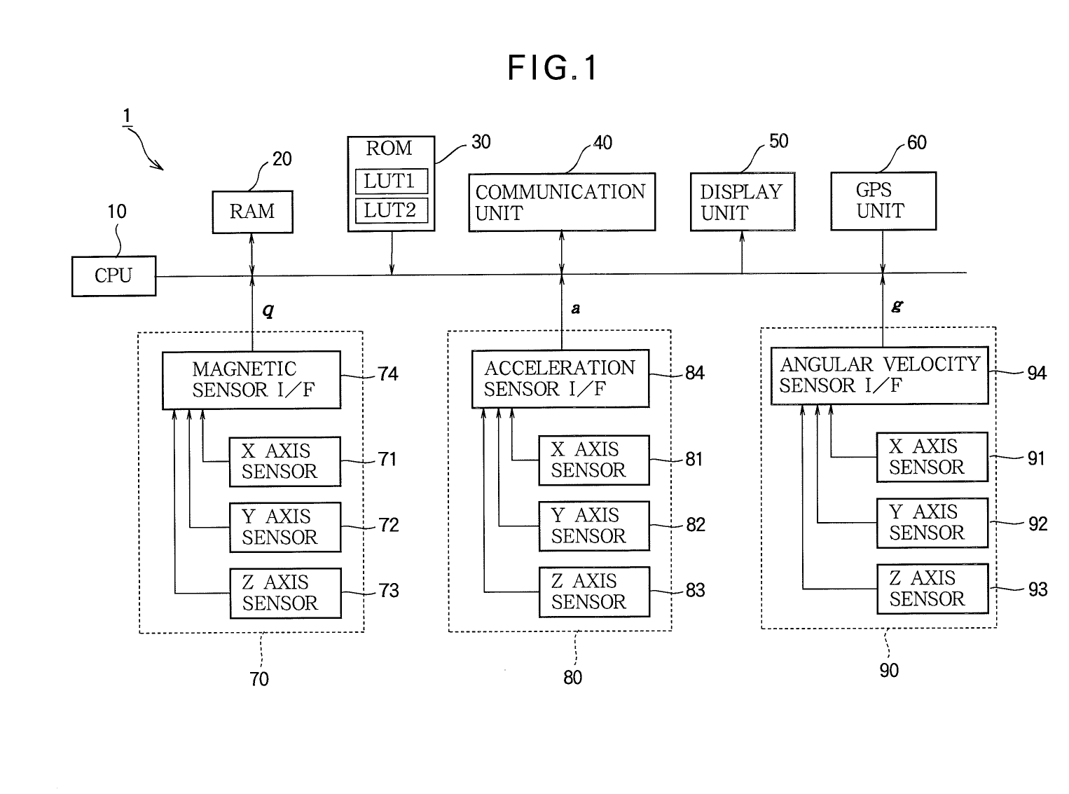

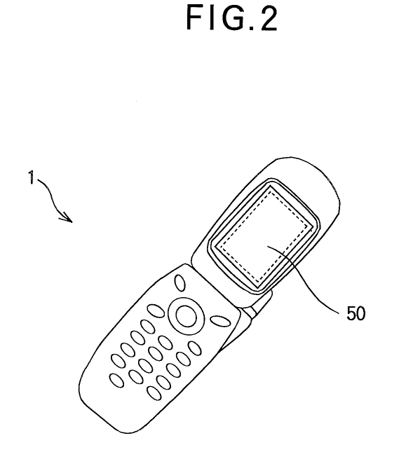

FIG. 1 is a block diagram of a portable instrument 1 according to an embodiment of the present invention, and FIG. 2 is a perspective view showing the external appearance of the portable instrument 1. The portable instrument 1 has a function to rotate a picture, such as a map, in response to the posture of a screen so that azimuth displayed by the picture follows that of a real space. This function is realized by performing Kalman filter operation based on outputs from various sensors to estimate the posture of the portable instrument 1 and the direction of geomagnetism when viewed from the portable instrument 1.

The portable instrument 1 includes a central processing unit (CPU) 10 connected to various kinds of constructional elements via buses for controlling the entirety of the apparatus, a random access memory (RAM) 20 functioning as a work area of the CPU 10, a read only memory (ROM) 30 for storing various kinds of programs and data, a communication unit 40 for performing communication, a display unit 50 for displaying a picture, and a global positioning system (GPS) unit 60. In case that ROM 30 is composed of a flash memory, it is possible to rewrite the various kinds of programs and data stored in the ROM 30 and to additionally write new data and programs. The GPS unit 60 receives a signal from a GPS satellite to generate position information (latitude and longitude) of the portable instrument 1. Also, the portable instrument 1 includes a three-dimensional magnetic sensor 70 for detecting geomagnetism to output magnetic data, a three-dimensional acceleration sensor 80 for detecting acceleration to output acceleration data, and a three-dimensional angular velocity sensor 90 for detecting angular velocity to output angular velocity data.

The three-dimensional magnetic sensor 70 includes an X axis magnetic sensor 71, a Y axis magnetic sensor 72, and a Z axis magnetic sensor 73. Each of the sensors can be configured using a magnetic impedance device (MI device) or a magnetic resistance effect device (MR device). A magnetic sensor interface (I/F) 74 converts analog output signals from the respective sensors into digital signals to output magnetic data q. The magnetic data q are vector data represented by x axis, y axis, and z axis components.

Meanwhile, the portable instrument 1, in which the three-dimensional magnetic sensor 70 is mounted, often includes a mechanical or electronic part generating a magnetic field, such as various kinds of metal that can be magnetized and electric circuits. For this reason, the magnetic data q output by the three-dimensional magnetic sensor 70 also include a vector representing a magnetic field generated by the part mounted in the portable instrument 1 in addition to a vector representing geomagnetism having a horizontal component directed to a north magnetic pole and a component perpendicular to a magnetic dip direction. In order to correctly detect a value of geomagnetism, therefore, it is necessary to perform correction process for removing a vector representing an internal magnetic field generated by the part of the portable instrument 1 from the vector data (magnetic data q) output by the three-dimensional magnetic sensor.

A vector representing the internal magnetic field to be removed from the data output from the three-dimensional magnetic sensor 70 to obtain a correct value of geomagnetism to be detected in the correction process is referred to as an offset q_{OFF} of the magnetic sensor.

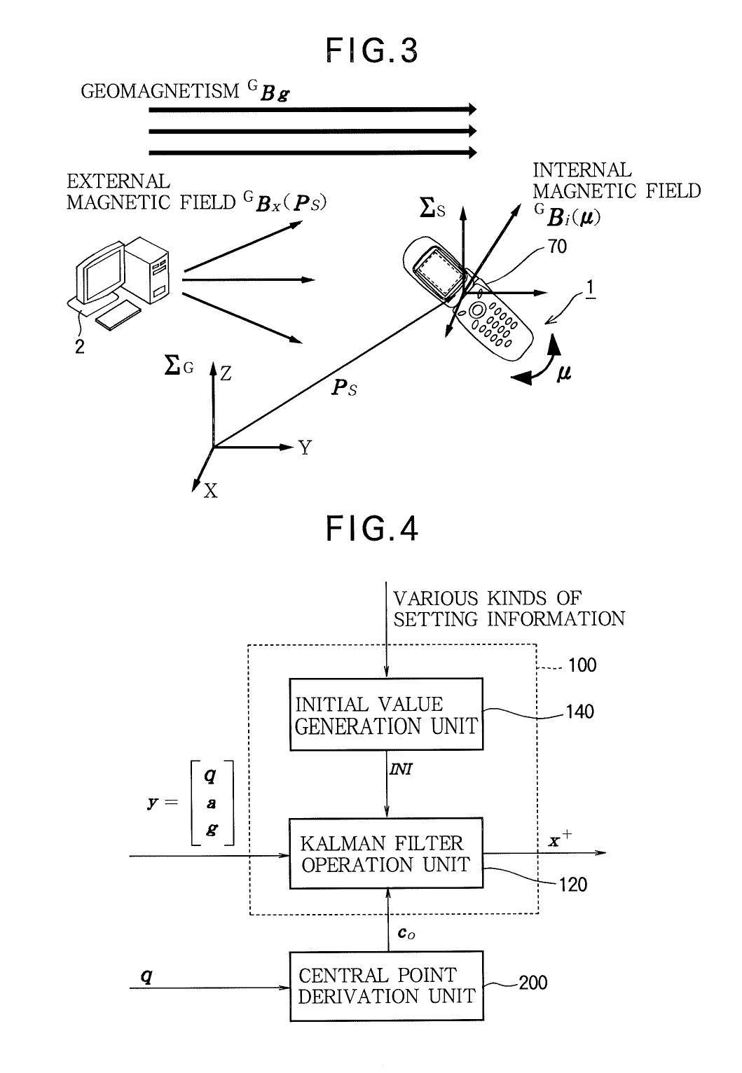

Also, as shown in FIG. 3, the three-dimensional magnetic sensor 70 may detect an external magnetic field Bₓ generated by an object 2 present outside the portable instrument 1 in addition to geomagnetism B_{g} and an internal magnetic field Bᵢ. The external magnetic field Bₓ is a nonuniform magnetic field, which will be described in detail below. Consequently, it is difficult to calculate the external magnetic field Bₓ component and to remove the calculated external magnetic field Bₓ component from output of the three-dimensional magnetic sensor 70, and therefore to calculate a correct value of the geomagnetism B_{g}. On the other hand, in a case in which the external magnetic field Bₓ is not present or in a case in which the influence of the external magnetic field Bₓ is little, it is possible to perform a process of removing the internal magnetic field Bᵢ from output of the three-dimensional magnetic sensor 70 as an offset, thereby calculating correct geomagnetism B_{g}.

For the convenience of description, a ground coordinate system Σ_{G} and a sensor coordinate system Σ_{S} are introduced as shown in FIG. 3. The ground coordinate system Σ_{G} is a coordinate system fixed to the ground. Specifically, the ground coordinate system Σ_{G} is a coordinate system having three directions perpendicular to each other, e.g. the horizontal east, the horizontal north, and the upper direction perpendicular thereto, as an x axis, y axis, and z axis with an arbitrary point on the ground as the origin. The sensor coordinate system Σ_{S} is a coordinate system fixed to the portable instrument 1. Magnetic data output by the three-dimensional magnetic sensor 70 are plotted on an x axis, y axis, and z axis of the sensor coordinate system Σ_{S} and are expressed as vector data of the sensor coordinate system Σ_{S}. Also, the position and posture of the origin of the sensor coordinate system Σ_{S} when viewed from the ground coordinate system Σ_{G} (that is, the position and posture of the portable instrument 1 when viewed from the ground coordinate system Σ_{G}) are expressed as a position P_{S} and a posture μ, respectively.

Meanwhile, a superscript G attached to the left upper part of each vector described in FIG. 3 means that each vector is expressed in the ground coordinate system Σ_{G}.

The three-dimensional acceleration sensor 80 includes an X axis acceleration sensor 81, a Y axis acceleration sensor 82, and a Z axis acceleration sensor 83. Each of the sensors may be a piezo resistance type sensor, a capacitive type sensor, or a heat detection type sensor. An acceleration sensor interface (I/F) 84 converts analog output signals from the respective sensors into digital signals to output acceleration data a. The acceleration data a are data representing resultant force of inertial force and gravity in a coordinate system fixed to the portable instrument 1, in which the three-dimensional acceleration sensor 80 is mounted, as a vector having x axis, y axis, and z axis components. When the portable instrument 1 is in a stationary state or in a uniform motion of straight line, therefore, the acceleration data a become vector data indicating the magnitude and direction of the acceleration of gravity in the coordinate system fixed to the portable instrument 1.

The three-dimensional angular velocity sensor 90 includes an X axis angular velocity sensor 91, a Y axis angular velocity sensor 92, and a Z axis angular velocity sensor 93. An angular velocity sensor interface (I/F) 94 converts analog output signals from the respective sensors into digital signals to output angular velocity data g. The angular velocity data g are vector data indicating rotational angular velocity of the respective axes.

The CPU 10 executes a state estimation program stored in the ROM 30 to estimate physical quantities (state variables), such as the posture of the portable instrument 1 and the offset of the magnetic sensor. That is, the CPU 10 executes the state estimation program, and therefore, the portable instrument 1 functions as a state estimation apparatus.

FIG. 4 is a functional block diagram showing a function realized by the CPU 10 as the state estimation apparatus executing the state estimation program. As shown in FIG. 4, the state estimation apparatus includes a state estimation unit 100 and a central point derivation unit 200. The state estimation unit 100 includes a Kalman filter operation unit 120 and an initial value generation unit 140. The Kalman filter operation unit 120 executes a Kalman filter operation using an observation vector y having the magnetic data q, the acceleration data a, and the angular velocity data g as components so as to periodically update a state vector x and to output a state vector x⁺ after update. The initial value generation unit 140 generates an initial value INI based on various kinds of setting information, and outputs the generated initial value INI.

The central point derivation unit 200 accumulates magnetic data q supplied from the three-dimensional magnetic sensor 70, calculates the coordinates of a central point (central point of a first spherical surface) cₒ based on a plurality of accumulated magnetic data q₁ to q_{N}, and outputs the calculated coordinates of the central point cₒ (N being a natural number, equal to or greater than 5, indicating a prescribed number of times for measuring magnetic data necessary to derive the coordinates of the central point cₒ at high precision). The central point cₒ is a point indicating coordinates on the sensor coordinate system Σ_{S}, and a vector indicating the coordinates of the central point cₒ becomes a candidate of the offset q_{OFF} of the magnetic sensor, which will be described in detail below.

### 2. KALMAN FILTER

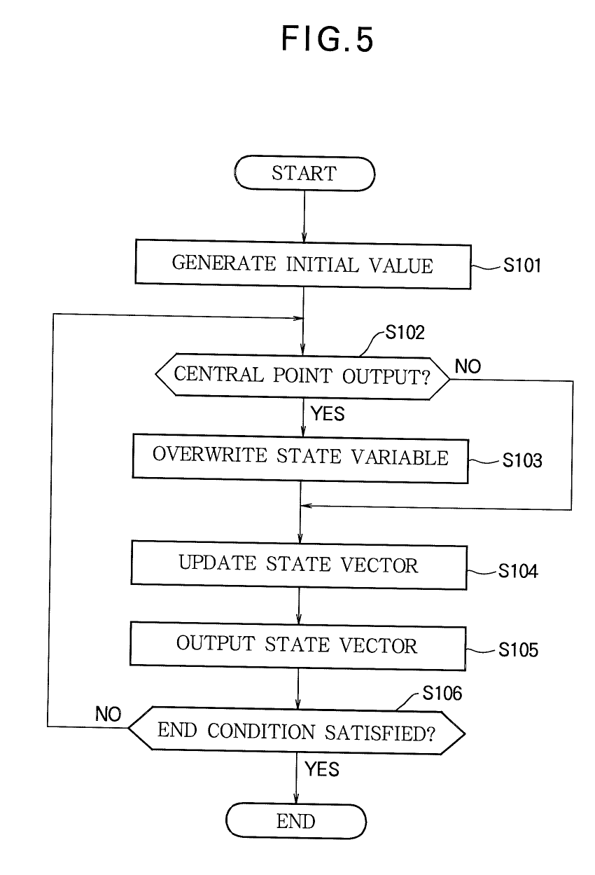

FIG. 5 is a flow chart showing the operation of the state estimation unit 100. A state estimation process shown in the flow chart is commenced by the CPU 10 executing a state estimation program.

At step S101, the CPU 10 performs an initial value generation process. Specifically, the CPU 10 generates an initial value INI with reference to various kinds of setting information recorded in the ROM 30. That is, the CPU 10 performs the initial value generation process of step S101, and therefore, the CPU 10 functions as the initial value generation unit 140.

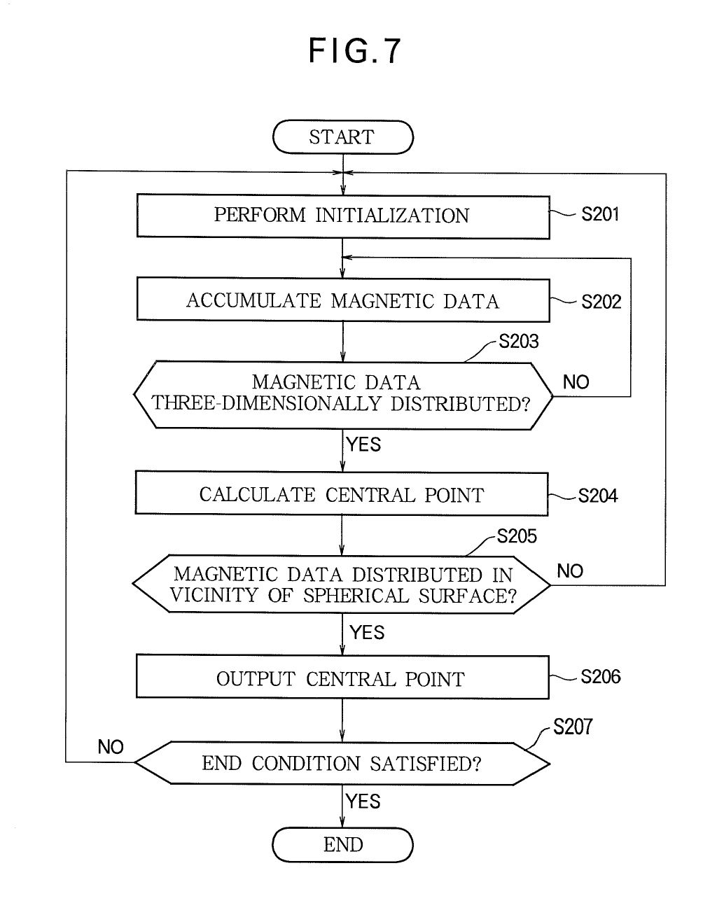

At step S102, the CPU 10 performs a central point deriving decision process. Specifically, the CPU 10 decides whether or not coordinates of a central point cₒ have been generated in a central point derivation process (see FIG. 7), which will be described below. (More specifically, the CPU 10 decides whether or not the coordinates of the central point cₒ have been derived from a central point output process of step S206, which will be described below.) Subsequently, in a case in which the coordinates of the central point cₒ have been generated in the central point derivation process, the CPU 10 advances the process to step S103. On the other hand, in a case in which the coordinates of the central point cₒ are not generated in the central point derivation process, the CPU 10 advances the process to step S104.

At step S103, the CPU 10 performs a state variable overwriting process. A state vector x, with respect to which a Kalman filter operation is to be performed in a state vector update process (step S104), is a vector having a plurality of state variables as components, and the vector components include an offset estimation value qₒ of the magnetic sensor, which is a three-dimensional vector, which will be described in detail below. In the state variable overwriting process, the CPU 10 overwrites the respective components constituting the offset estimation value qₒ of the magnetic sensor, which is the three-dimensional vector, by three axis coordinate components representing the central point cₒ obtained by the central point derivation process.

At step S104, the CPU 10 performs a state vector update process. Specifically, the CPU 10 performs a Kalman filter operation using an observation vector y to periodically update a state vector x and to output a state vector x⁺ after update.

At step S105, the CPU 10 performs a state vector output process. Specifically, the CPU 10 outputs the state vector x⁺ after update calculated in the state vector update process.

The CPU 10 performs the processes of steps S102 to S105 as described above, and therefore, the CPU 10 functions as the Kalman filter operation unit 120. Consequently, it is possible for the portable instrument 1 to successively calculate the current direction of geomagnetism Bg and the current posture of the portable instrument 1 using a state vector x⁺ₖ after update (that is, a plurality of state variables) generated by the CPU 10 performing the processes of steps S102 to S105.

Subsequently, the CPU 10 decides whether or not an end condition for ending the state estimation program is satisfied (step S106). The end condition may be properly set based on the specification of the portable instrument 1. For example, turning off the portable instrument 1 may be set as the end condition. In a case in which the end condition is satisfied, the CPU 10 ends the state estimation process shown in the flow chart. On the other hand, in a case in which the end condition is not satisfied, the CPU 10 advances the process to step S102.

Generally, a Kalman filter has a state transition model for estimating time-based change of a plurality of physical quantities representing the state of a dynamic system and an observation model for estimating a value (observed value) measured by a plurality of sensors included in the dynamic system. Also, the Kalman filter estimates a state vector after the lapse of unit time from a state vector having a plurality of physical quantities (state variables) representing the state of the dynamic system at a certain time as elements using the state transition model. Subsequently, the Kalman filter estimates a value of an observation vector having output values of a plurality of sensors for measuring the state of the dynamic system as elements based on the estimated state vector. In addition, the Kalman filter updates the estimated state vector to a value approximate to a real value (true value) based on an observation residual calculated as the difference between the estimated observation vector and an observation vector having real output values of the sensors as elements, and outputs a state vector after update.

The Kalman filter repeats the above-described operation to bring each of the state variables constituting the state vector close to a value (true value) correctly indicating physical quantities as approximate to real physical quantities as possible.

In this embodiment, the Kalman filter adopts the posture p of the portable instrument 1, strength r of geomagnetism, a magnetic dip φ of the geomagnetism, angular velocity ω of the portable instrument 1, offset estimation values gₒ of the angular velocity sensors 91 to 93, and offset estimation values qₒ of the magnetic sensors 71 to 73 as the state variables, with respect to which estimation is performed. Meanwhile, the reason that the offset estimation values gₒ of the angular velocity sensors are included in the state variables is that offsets of the angular velocity sensors 91 to 93 overlap with angular velocity data g.

A state vector xₖ, having these state variables as elements, at time T=k is represented by the following equation (1). Meanwhile, a subscript k attached to the right lower part of each of the state variables indicates that each of the state variables is a value at time T=k.

$${x}_{k} = [ \begin{matrix}{μ}_{k} \\ {r}_{k} \\ {φ}_{k} \\ {ω}_{k} \\ {g}_{O , k} \\ {q}_{O , k}\end{matrix} ] \qquad ( 1 )$$

In this embodiment, a posture μ is expressed using a quaternion. The quaternion is a four-dimensional number representing a posture (rotational state) of an object. Specifically, a posture μ when the respective axes of the sensor coordinate system Σ_{S} fixed to the portable instrument 1 coincide with the respective axes of the ground coordinate system Σ_{G} is defined as a reference posture, and the reference posture is expressed as μ=(0, 0, 0, 1). At this time, an arbitrary posture μ of the portable instrument 1 can be expressed as a posture when the portable instrument 1 is rotated by an angle ψ in the direction of a unit vector α as a rotational axis with respect to the reference posture. A posture μ after rotation is represented by equation (2).

$$μ = [ \begin{matrix}{μ}_{1} \\ {μ}_{2} \\ {μ}_{3} \\ {μ}_{4}\end{matrix} ] = [ \begin{matrix}α sin ( \frac{ψ}{2} ) \\ cos ( \frac{ψ}{2} )\end{matrix} ] \qquad ( 2 )$$

In this embodiment, targets to be observed by the Kalman filter are magnetic data q output from the three axis magnetic sensors 71 to 73, acceleration data a output from the three axis acceleration sensors 81 to 83, and angular velocity data g output from the three axis angular velocity sensors 91 to 93. At this time, an observation vector yₖ at time T=k is represented by equation (3).

$${y}_{k} = [ \begin{matrix}{q}_{k} \\ {a}_{k} \\ {g}_{k}\end{matrix} ] \qquad ( 3 )$$

As previously described, the initial value generation unit 140 generates an initial value INI having state variables at time T=0 as elements (initial value generation process). The initial value INI includes an initial value μ₀ of a posture μ, an initial value r₀ of strength r of geomagnetism, an initial value φ₀ of a magnetic dip φ of the geomagnetism, an initial value ψₒ of angular velocity ψ, an initial value g_{o,0} of an offset estimation value gₒ of the angular velocity sensor, and an initial value q_{o,0} of an offset estimation value qₒ of the magnetic sensor as the elements.

The initial value INI may be properly set to a value, by which the state variables converge to a correct value as rapidly as possible by the Kalman filter operation. For example, the initial value INI may be set to the following value.

The initial value r₀ of the strength r of the geomagnetism and the initial value φ₀ of the magnetic dip φ of the geomagnetism can be generated based on position information supplied from the GPS unit 60. This is because, if a position on the earth can be specified, it is possible to detect the strength and magnetic tip of the geomagnetism at the position. Specifically, a lookup table LUT1 containing the position information and the strength and magnetic tip of the geomagnetism in a corresponding fashion is stored in the ROM 30. The initial value generation unit 140 sets the strength and magnetic tip of the geomagnetism corresponding to the position information as the initial value r₀ of the strength r of the geomagnetism and the initial value φ₀ of the magnetic dip φ of the geomagnetism with reference to the lookup table LUT1.

Meanwhile, in a case in which the portable instrument 1 is located at a place which a radio wave from a satellite does not reach (for example, an underground passage), it is not possible to obtain position information from the GPS unit 60. In such a case, a typical value of a region at which the portable instrument 1 can be used may be adopted. This value is also stored in the lookup table LUT1. In a case in which it is not possible to obtain position information, the initial value generation unit 140 reads the typical value from the lookup table LUT1. For example, for a portable instrument 1 sold in Japan, the initial value r₀ of the strength r of the geomagnetism and the initial value φ₀ of the magnetic dip φ of the geomagnetism are calculated based on strength and magnetic dip of geomagnetism at Akashi.

The initial value ω₀ of the angular velocity ψ, is set to 0, for example, on the assumption that the portable instrument 1 is in a stationary state. The initial value g_{o,0} of the offset estimation value gₒ of the angular velocity sensor is generally adjusted to approximate to 0, and therefore, the initial value g_{o,0} of the offset estimation value gₒ of the angular velocity sensor is set to 0. The initial value μ₀ of the posture μ is set to a value reducing misalignment with a real initial posture, for example, on the assumption that the portable instrument 1 is in a stationary state while the portable instrument 1 is oriented in a regular direction.

The initial value q_{o,0} of the offset estimation value gₒ of the magnetic sensor is set to a value represented by the following equation (4), for example, using an observed value qₒ of the magnetic sensor at time T=0, the initial value μ₀ of the posture μ, a geomagnetic vector q_{typical} of a region at which the portable instrument 1 is used, and a matrix B(μ) represented by equation (5). Here, in a case in which the portable instrument 1 assumes the posture μ, the matrix B(μ) is a coordinate conversion matrix for converting coordinates of a vector expressed in the ground coordinate system Σ_{G} so that the vector can be expressed in the sensor coordinate system Σ_{S}. Meanwhile, a lookup table LUT2 containing the position information and the geomagnetic vector q_{typical} in a corresponding fashion is stored in the ROM 30. The initial value generation unit 140 acquires the geomagnetic vector q_{typical} with reference to the lookup table LUT2 based on the position information generated by the GPS unit 60, and operates equation (4) to obtain the initial value q_{o,0} of the offset estimation value qₒ of the magnetic sensor.

$$\begin{matrix} {q}_{O , 0} = {q}_{0} - B ( {μ}_{0} ) {q}_{typical} & ( 4 ) \\ where \\ B ( μ ) = [ \begin{matrix}{μ}_{4}^{2} + {μ}_{1}^{2} - {μ}_{2}^{2} - {μ}_{3}^{2} & 2 ( {μ}_{1} {μ}_{2} + {μ}_{4} {μ}_{3} ) & 2 ( {μ}_{1} {μ}_{3} - {μ}_{4} {μ}_{2} ) \\ 2 ( {μ}_{2} {μ}_{1} - {μ}_{4} {μ}_{3} ) & {μ}_{4}^{2} - {μ}_{1}^{2} + {μ}_{2}^{2} - {μ}_{3}^{2} & 2 ( {μ}_{2} {μ}_{3} + {μ}_{4} {μ}_{1} ) \\ 2 ( {μ}_{3} {μ}_{1} + {μ}_{4} {μ}_{2} ) & 2 ( {μ}_{3} {μ}_{2} - {μ}_{4} {μ}_{1} ) & {μ}_{4}^{2} - {μ}_{1}^{2} - {μ}_{2}^{2} + {μ}_{3}^{2}\end{matrix} ] & ( 5 )\end{matrix}$$

The initial value generation unit 140 generates and outputs the initial value INI, which is a vector having the initial value μ₀ of the posture μ, the initial value r₀ of the strength r of the geomagnetism, the initial value φ₀ of the magnetic dip φ of the geomagnetism, the initial value ω₀ of the angular velocity ω, the initial value g_{o,0} of the offset estimation value gₒ of the angular velocity sensor, and the initial value q_{o,0} of the offset estimation value qₒ of the magnetic sensor, generated as described above, as the elements.

### 3. KALMAN FILTER OPERATION

Next, contents of the state vector update process, performed at step S104, i.e. contents of the operation performed by the Kalman filter according to this embodiment, will be described.

The Kalman filter estimates a state vector xₖ after the lapse of unit time (at time T=k) from a state vector xₖ₋₁ indicating the state of the dynamic system at a certain time (at time T=k−1) using the state transition model representing time-based change in the state of the dynamic system, and outputs this estimated value as an estimated state vector x⁻ₖ. Also, the Kalman filter estimates an observation vector yₖ based on the state vector x⁻ₖ estimated by the state transition model using the observation model representing a relationship between an observation vector yₖ having outputs from various sensors as elements and the state vector xₖ, and outputs this estimated value as an estimated observation vector y⁻ₖ.

Meanwhile, in this embodiment, a sigma point Kalman filter, which is a nonlinear Kalman filter, is used as the Kalman filter, which will be described in detail below. The sigma point Kalman filter is an operation for setting a plurality of sigma points Xₖ₋₁ in the vicinity of the state vector xₖ₋₁ and applying these sigma points Xₖ₋₁ to the state transition model to estimate sigma points X⁻ₖ after the lapse of unit time and to calculate an average of the estimated sigma points X⁻ₖ, thereby finding the estimated state vector x⁻ₖ. Strictly speaking, therefore, the estimated observation vector y⁻ₖ is calculated based on the estimated sigma points X⁻ₖ present in the vicinity of the estimated state vector x⁻ₖ.

Subsequently, the Kalman filter calculates the difference between the estimated observation vector y⁻ₖ and the observation vector yₖ having real observed values as elements as an observation residual zₖ, and calculates a Kalman gain Kₖ based on the observation residual zₖ. In addition, the Kalman filter updates the estimated state vector x⁻ₖ using the observation residual zₖ and the Kalman gain Kₖ to calculate a state vector x⁺ₖ after update.

The state vector update process is a process of bringing the state vector xₖ close to a correct value approximate to a value (true value) correctly indicating real physical quantities through the Kalman filter operation to repeat update of the state vector xₖ as described above.

[3.1. Outline of Kalman Filter Operation]

In this embodiment, the state transition model of the Kalman filter is represented by the following equation (6), and the observation model is represented by the following equation (7). Meanwhile, in this embodiment, a function f present in equation (6) and a function h present in equation (7) are nonlinear functions.

xₖ=f(xₖ₋₁,k−1)+wₖ₋₁ (6)

yₖ=h(xₖ,k)+vₖ (7)

Here, the state vector xₖ is an a-dimensional vector, and the observation vector yₖ is a b-dimensional vector. Meanwhile, in this embodiment, a=15, and b=9. Also, a process noise wₖ present in equation (6) and an observed noise vₖ present in equation (7) are Gauss noises having 0 as the center.

Equation (6) indicates that the state vector xₖ at time T=k is estimated by adding a value obtained by substituting the state vector xₖ₋₁ at time T=k−1 into the function f to a process noise wₖ₋₁ at time T=k−1.

Also, equation (7) indicates that the observation vector yₖ at time T=k is estimated by adding a value obtained by substituting the state vector xₖ at time T=k into the function h to an observed noise vₖ at time T=k.

Meanwhile, a covariance of the process noise wₖ is denoted by Qₖ, and a covariance of the observed noise vₖ is denoted by Rₖ.

The observation residual zₖ at time T=k is a vector set based on the real observation vector yₖ and the estimated observation vector y⁻ₖ, and is represented by the following equation (8). The Kalman filter updates the estimated state vector x⁻ₖ as represented by the following equation (10) using the observation residual zₖ and a Kalman gain Kₖ represented by equation (9) to calculate a state vector x⁺ₖ after update. Also, the Kalman filter updates a covariance Pₖ of an estimated error of the state vector xₖ as represented by the following equation (11).

zₖ=yₖ−h(xₖ⁻,k) (8)

Kₖ=Pₖ^{xy}(Pₖ^{yy})⁻¹ (9)

xₖ⁺=xₖ⁻−Kₖzₖ (10)

Pₖ⁺=Pₖ⁻−KₖPₖ^{yy}Kₖ^{T} (11)

Where, P⁻ₖ is a covariance of an estimated error of x⁻ₖ, P⁺ₖ is a covariance of an estimated error of x⁺ₖ, Pₖ^{yy} is a covariance of an observation residual, and pₖ^{xy} is a mutual variance-covariance matrix of x⁻ₖ and y⁻ₖ.

The observation vector y⁻ₖ estimated using the observation model is logic value calculated by applying the state vector x⁻ₖ estimated using the state transition model to the observation model as represented by equation (7). Consequently, the difference between the observation vector y⁻ₖ estimated using the observation model and the observation vector yₖ based on real sensor outputs, i.e. the observation residual zₖ, is a value indicating a degree of approximation between the estimated state vector x⁻ₖ and a value (true value) correctly representing real physical quantities.

In equation (10), the estimated state vector x⁻ₖ is updated to a state vector x⁺ₖ after update, which is approximate to the true value, using the observation residual zₖ.

[3.2. Operation Performed by Sigma Point Kalman Filter]

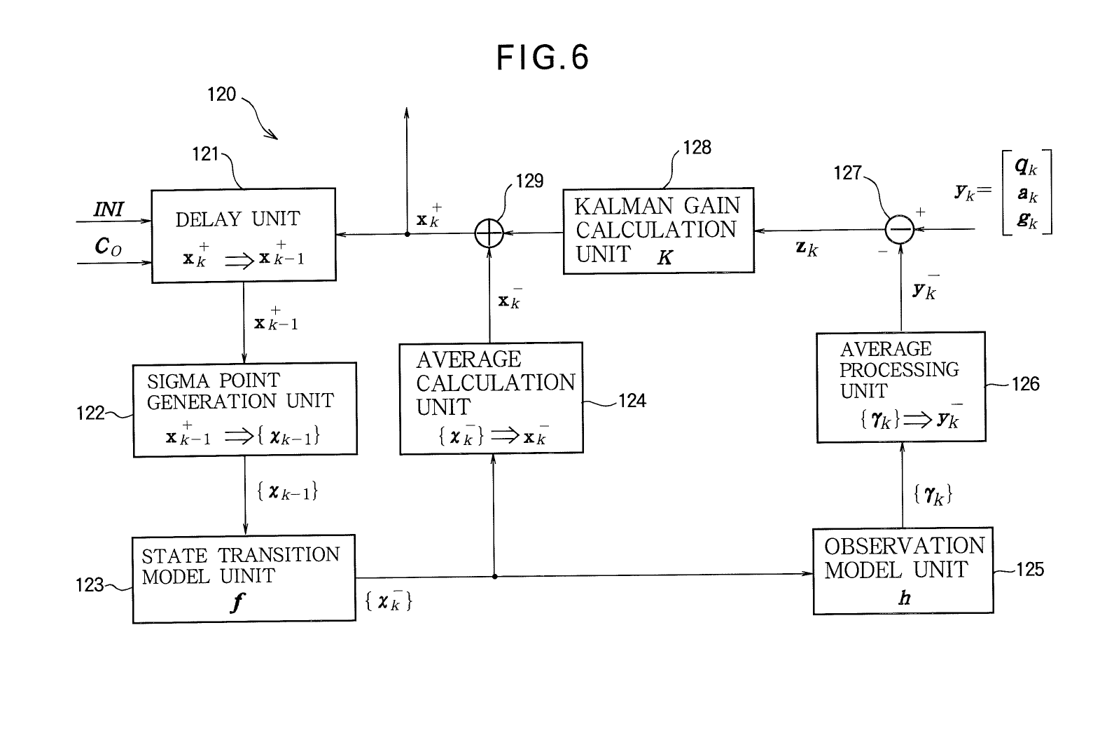

Meanwhile, in this embodiment, the Kalman filter (Kalman filter operation unit 120) is constituted by a sigma point Kalman filter using unscented transformation. Hereinafter, updating of a state vector by the sigma point Kalman filter will be described in detail with reference to a functional block diagram of the Kalman filter operation unit 120 shown in FIG. 6.

A delay unit 121 delays a state vector x⁺ₖ after update output from an adder 129 by unit time (time from time T=k−1 to time T=k) to generate a state vector x⁺ₖ₋₁ and outputs the generated state vector to a sigma point generation unit 122. Meanwhile, in the first operation (time T=0), the delay unit 121 generates the state vector x⁺ₖ₋₁ using the initial value INI output by the initial value generation unit 140.

Also, in a case in which the central point derivation unit 200 outputs a central point cₒ, the delay unit 121 overwrites an element of the state vector x⁺ₖ₋₁ corresponding to the offset estimation value qₒ of the magnetic sensor using the central point cₒ output from the central point derivation unit 200 to generate the state vector x⁺ₖ₋₁ (state variable overwriting process of step S103).

The sigma point generation unit 122 generates 2a+1 sigma points using variance-covariance matrices P⁺ₖ₋₁ and Qₖ₋₁ of a x a. Specifically, first, with respect to an average of a plurality of sigma points, a vector σₖ represented by equation (12) and equation (13) is defined using a scaling parameter λ representing extension of the signal points about the average.

σₖ(j)=\sqrt{(a+λ)(Pₖ⁺+Qₖ)}(j=1, . . . , a) (12)

σₖ(a+j)=−\sqrt{(a+λ)(Pₖ⁺+Qₖ)}(j=1, . . . , a) (13)

where, P satisfying ZZ^{T}=Z is represented by √P.

At this time, the sigma point generation unit 122 generates 2a+1 sigma points Xₖ₋₁ represented by equation (14) and equation (15) based on a vector σₖ₋₁ and the state vector x⁺ₖ₋₁.

Xₖ₋₁(0)=xₖ₋₁⁺ (14)

Xₖ₋₁(j)=σₖ₋₁(j)+xₖ₋₁⁺(j=1, . . . , 2a) (15)

A state transition model unit 123 applies 2a+1 sigma points Xₖ₋₁(j) at time T=k−1 to the state transition model to calculate estimated values X⁻ₖ(j) of the 2a+1 sigma points at time T=k as represented by equation (16).

Xₖ⁻(j)=f(Xₖ₋₁(j),k−1)(j=0, . . . , 2a) (16)

Subsequently, an average calculation unit 124 calculates an average value of the estimated values X⁻k of the 2a+1 sigma points at time T=k to calculate an estimated state vector x⁻ₖ as represented by equation (17).

$${x}_{k}^{-} - \frac{1}{a + λ} ( {x}_{{χ}_{ch}^{-} ( 0 )} + \frac{1}{2} {\sum }_{j = 1}^{2 a} {χ}_{k}^{-} ( j ) ) \qquad ( 17 )$$

Also, the average calculation unit 124 calculates a covariance P⁻ₖ of an error of the estimated state vector x⁻ₖ represented by equation (18).

$${P}_{k}^{-} = \frac{1}{a + λ} ( λ {ξ}_{0} {ξ}_{0}^{T} + \frac{1}{2} {\sum }_{j = 1}^{2 a} {ξ}_{j} {ξ}_{j}^{T} ) \\ where \\ {ξ}_{j} = {χ}_{k}^{-} ( j ) - {x}_{k}^{-} \qquad ( 18 )$$

On the other hand, an observation model unit 125 applies 2a+1 sigma points Xₖ(j) at time T=k to the observation model to calculate 2a+1 estimated observed values γₖ(j) as represented by equation (19).

γₖ(j)=h(Xₖ⁻(j),k−1)(j=0, . . . , 2a) (19)

An average processing unit 126 calculates an average of the 2a+1 estimated observed values γₖ(j) to calculate an estimated observation vector y⁻ₖ as represented by equation (20).

$${y}_{k}^{-} = \frac{1}{a + λ} ( {λγ}_{k} ( 0 ) + \frac{1}{2} {\sum }_{j = 1}^{2 a} {γ}_{k} ( i ) ) \qquad ( 20 )$$

Subsequently, the average processing unit 126 calculates a covariance P^{yy}ₖ of an observation residual represented by equation (21).

$${P}_{k}^{yy} = \frac{1}{a + λ} ( λ {ζ}_{0} {ζ}_{0}^{T} + \frac{1}{2} {\sum }_{j = 1}^{2 a} {ζ}_{j} {ζ}_{j}^{T} ) + {R}_{k} \\ where {ζ}_{j} = {γ}_{k} ( j ) - {y}_{k}^{-} \qquad ( 21 )$$

A subtractor 127 calculates the observation residual zₖ as the difference between the observation vector yₖ and the estimated observation vector y⁻ₖ as represented by equation (8).

A Kalman gain grant unit 128 calculates a mutual variance-covariance matrix P^{xy}ₖ represented by equation (22). In addition, the Kalman gain grant unit 128 calculates a Kalman gain Kₖ based on the covariance P^{yy}ₖ of the residual and the mutual variance-covariance matrix P^{xy}ₖ as represented by equation (9), and executes an operation of a second term (Kₖzₖ) of the right side of equation (10). Also, the Kalman gain grant unit 128 updates the covariance Pₖ of the estimated error of the state vector xₖ from P⁻ₖ to P⁺ₖ as represented by equation (11).

$${P}_{k}^{xy} = \frac{1}{a + λ} ( {λξ}_{0} {ζ}_{0}^{T} + \frac{1}{2} {\sum }_{j = 1}^{2 a} {ξ}_{j} {ζ}_{j}^{T} ) \qquad ( 22 )$$

The adder 129 adds the estimated state vector x⁻ₖ to the second term (Kₖzₖ) of the right side of equation (10) output from the Kalman gain grant unit 128 to calculate a state vector x⁺ₖ after update as represented by equation (10).

[3.3. State Transition Model]

Hereinafter, the state transition model used in the operation of the state transition model unit 123 will be described.

In the state transition model according to this embodiment, state transition of the posture μ of the state variables constituting the state vector xₖ is defined by equation (23). Equation (23) represents an operation of estimating a posture μₖ at time T=k after the lapse of unit time from a posture μₖ₋₁ at time T=k−1. Here, μ⁻ₖ is an element of a state vector x⁻ₖ estimated at time k corresponding to the state variable representing the posture μ.

Meanwhile, an operator Ω present at the right side of equation (23) is defined by equation (24). Here, I_{3×3} represents a unit matrix of 3×3. With respect to a three-dimensional vector l=(l₁, l₂, l₃), an operator [lX] is defined by equation (25). Also, when a measurement time interval (an interval from time T=k−1 to time T=k) is denoted by Δt, and an element corresponding to the state variable representing the angular velocity of the state vector x⁺ₖ after update at time T=k is denoted by ω⁺k, a component ψ⁺k constituting the operator Ω is defined by equation (26).

$$\begin{matrix}{μ}_{k}^{-} = Ω ( {ω}_{k - 1}^{+} ) {μ}_{k - 1}^{+} \\ where & ( 23 ) \\ Ω ( {ω}_{k}^{+} ) = [ \begin{matrix}cos ( \frac{1}{2} ‖ {ω}_{k}^{+} ‖ Δ t ) {I}_{3 \times 3} - [ {Ψ}_{k}^{+} \times ] & {Ψ}_{k}^{+} \\ - {Ψ}_{k}^{+ T} & cos ( \frac{1}{2} ‖ {ω}_{k}^{+} ‖ Δ t )\end{matrix} ] & ( 24 ) \\ [ l \times ] = [ \begin{matrix}0 & - {l}_{3} & {l}_{2} \\ {l}_{3} & 0 & - {l}_{1} \\ - {l}_{2} & {l}_{1} & 0\end{matrix} ] & ( 25 ) \\ {Ψ}_{k}^{+} = sin ( \frac{1}{2} ‖ {ω}_{k}^{+} ‖ Δ t ) \frac{{ω}_{k}^{+}}{‖ {ω}_{k}^{+} ‖} & ( 26 )\end{matrix}$$

Since the posture μ is expressed using a quaternion, a normalization condition of ∥μ∥=1 must be satisfied. If an average of the sigma points is found, however, the normalization condition is not satisfied. For this reason, when any operation is performed with respect to the posture μ, the result after operation is normalized to the size of the vector. Meanwhile, in order to more strictly maintain the normalization condition, the posture μₖ of the state vector xₖ may be limited only to information regarding difference between the present time and the previous time using modified Rodrigues parameters (MPRs), and posture information outside the Kalman filter may be updated based on difference information obtained from the Kalman filter.

It is difficult to predict change of the strength r and magnetic dip φ of the geomagnetism. For this reason, in the state transition model according to this embodiment, it is assumed that strength rₖ and magnetic dip φₖ of the geomagnetism at time T=k are equal to strength rₖ₋₁ and magnetic dip φₖ₋₁ of the geomagnetism at time T=k−1 for the sake of convenience.

In the same manner, it is difficult to predict change of the offset estimation value gₒ of the angular velocity sensor. For this reason, in the state transition model according to this embodiment, it is assumed that an offset estimation value g_{o, k} of the angular velocity sensor at time T=k is equal to an offset estimation value g_{o,k-1} of the angular velocity sensor at time T=k−1 for the sake of convenience.

Since the angular velocity ω of the portable instrument 1 is changed depending upon the movement of the portable instrument 1 caused by a user of the portable instrument 1, it is difficult to formalize angular velocity ωₖ at time T=k using angular velocity ωₖ₋₁ at time T=k−1. For this reason, in the state transition model according to this embodiment, it is assumed that the angular velocity ωₖ at time T=k is equal to the angular velocity ωₖ₋₁ at time T=k−1 for the sake of convenience.

As previously described, the offset q_{OFF} of the magnetic sensor is a vector expressing the direction and magnitude of the internal magnetic field Bᵢ generated by the part of the portable instrument 1 in the sensor coordinate system Σ_{S}. In a case in which the internal state of the portable instrument 1 is uniform, therefore, the offset q_{OFF} of the magnetic sensor is also not changed. On the other hand, in a case in which the internal state of the portable instrument 1 is changed, for example, in a case in which the magnitude of current flowing in the part mounted in the portable instrument 1 is changed or in a case in which the magnetized state of the part mounted in the portable instrument 1 is changed, the offset q_{OFF} of the magnetic sensor is also changed. That is, the internal state of the portable instrument 1 is changed depending upon user manipulation of the portable instrument 1 and external environment of the portable instrument 1. Consequently, it is difficult to predict the timing at which the offset q_{OFF} of the magnetic sensor is changed and the change amount of the offset q_{OFF} of the magnetic sensor, and it is difficult to formalize an offset estimation value q_{o,K} of the magnetic sensor at time T=k using an offset estimation value q_{0,K-1} of the magnetic sensor at time T=k−1.

For this reason, in the state transition model according to this embodiment, it is assumed that the offset estimation value q_{o,K} of the magnetic sensor at time T=k is equal to the offset estimation value q_{0,K-1} of the magnetic sensor at time T=k−1 for the sake of convenience.

In this way, in the state transition model according to this embodiment, it is premised that the remaining portions of the state variables constituting the state vector xₖ except the state variable representing the posture μ are not changed from the previous time as represented by the following equation (27).

$$[ \begin{matrix}{r}_{k} \\ {φ}_{k} \\ {ω}_{k} \\ {g}_{O , k} \\ {q}_{O , k}\end{matrix} ] = [ \begin{matrix}{r}_{k - 1} \\ {φ}_{k - 1} \\ {ω}_{k - 1} \\ {g}_{O , k - 1} \\ {q}_{O , k - 1}\end{matrix} ] \qquad ( 27 )$$

Meanwhile, in the Kalman filter operation, the state vector xₖ is updated based on the observation residual zₖ. Consequently, all of the values indicated in equation (27) except the posture μ are changed. The state vector xₖ is undated so as to approximate to a real value based on the observation residual zₖ by the adder 129.

Specifically, a state vector xₖ at time T=k is updated based on an observation residual zₖ calculated using a state vector xₖ₋₁ at time T=k−1 as represented by equation (6), equation (8), and equation (10). In the same manner, the state vector xₖ₋₁ at time T=k−1 is updated based on an observation residual zₖ₋₁ calculated using a state vector xₖ₋₂ at time T=k−2. That is, in the Kalman filter operation, the state vector xₖ is updated in consideration of values of all state vectors x₀ to xₖ₋₁ ranging from the initial state (time T=0) to time T=k−1. In a case in which the value of the state vector xₖ converges to a value greatly deviating from a real value, therefore, the value of the state vector xₖ may not approximate to the real value although the Kalman filter operation is repeated afterward. Also, even if the value of the state vector xₖ approximates to the real value, it takes a long time until the value of the state vector xₖ converges to the real value.

As previously described, the offset q_{OFF} of the magnetic sensor may be suddenly greatly changed with the change in internal state of the portable instrument 1. In a case in which the offset q_{OFF} of the magnetic sensor is suddenly greatly changed, the offset estimation value q_{o,K} of the magnetic sensor and the offset q_{OFF} (real value) of the magnetic sensor greatly differ from each other. In a case in which the offset estimation value q_{o,K} of the magnetic sensor greatly deviates from the real value, the offset estimation value q_{o,K} of the magnetic sensor may not approximate to the real value although the state vector xₖ is repeatedly updated by the Kalman filter. Also, even if the offset estimation value q_{o,K} of the magnetic sensor can approximate to the real value, it takes a long time until the offset estimation value q_{o,K} of the magnetic sensor converges to the real value. In a case in which the offset estimation value q_{o,k} of the magnetic sensor is greatly different from the real value, it is possible for the portable instrument 1 to calculate the direction of the geomagnetism B_{g} and the posture μ of the portable instrument 1.

In this embodiment, therefore, in a case in which the coordinates of the central point cₒ are output from the central point derivation unit 200, the offset estimation value gₒ of the magnetic sensor is overwritten using the coordinates of the central point cₒ (state variable overwriting process of step S103).

The coordinates of the central point cₒ is calculated based on N magnetic data q₁ to q_{N}. Consequently, it is possible for the central point derivation unit 200 to calculate the coordinates of the central point cₒ correctly representing the offset q_{OFF} of the magnetic sensor using N magnetic data q₁ to q_{N} acquired after the change of the offset q_{OFF} of the magnetic sensor although the offset q_{OFF} of the magnetic sensor is suddenly greatly changed. That is, the coordinates of the central point cₒ are calculated as a value closer to a real value corresponding to sudden change of the offset q_{OFF} of the magnetic sensor than the offset estimation value q_{0,k} of the magnetic sensor calculated in consideration of the values of all of the state vectors x₀ to xₖ₋₁ ranging from the initial state (time T=0) to time T=k−1.

Even in a case in which the offset q_{OFF} of the magnetic sensor is suddenly greatly changed, therefore, it is possible for the state estimation apparatus according to this embodiment to overwrite the offset estimation value qₒ of the magnetic sensor using the coordinates of the central point cₒ, thereby preventing the state vector xₖ from deviating from the real value.

[3.4. Observation Model]

Hereinafter, the observation model used in the operation performed by the observation model unit 125 will be described.

An estimated value γ_{gyro} of the angular velocity data g output from the three-dimensional angular velocity sensor 90 is represented by equation (28) using the angular velocity ω and the offset estimation value gₒ of the angular velocity sensor.

γ_{gyro}=ω+gₒ (28)

Also, in the observation model, a geomagnetic vector in the ground coordinate system Σ_{G} is represented by equation (29). Consequently, an estimated value γ_{mag} of the magnetic data q output from the three-dimensional magnetic sensor 70 is represented by equation (30) using the offset estimation value gₒ of the angular velocity sensor and the matrix B(μ) represented by equation (5).

$$\begin{matrix}[ \begin{matrix}0 \\ r cos φ \\ - r sin φ\end{matrix} ] & ( 29 ) \\ {γ}_{mag} = B ( μ ) [ \begin{matrix}0 \\ r cos φ \\ - r sin φ\end{matrix} ] + {q}_{o} & ( 30 )\end{matrix}$$

Also, in the observation model, a gravity vector in the ground coordinate system Σ_{G} is normalized to the acceleration of gravity, and is represented by equation (31). Consequently, an estimated value γ_{acc} of the acceleration data a output from the three-dimensional acceleration sensor 80 is represented by equation (32) using the matrix B(μ) represented by equation (5)

$$\begin{matrix}[ \begin{matrix}0 \\ 0 \\ - 1\end{matrix} ] & ( 31 ) \\ {γ}_{acc} = B ( μ ) [ \begin{matrix}0 \\ 0 \\ - 1\end{matrix} ] & ( 32 )\end{matrix}$$

Consequently, equation (3), equation (28), equation (30), and equation (32) are applied to equation (8) so that the observation residual zₖ is represented by equation (33).

$${z}_{k} = [ \begin{matrix}{q}_{k} \\ {a}_{k} \\ {g}_{k}\end{matrix} ] - [ \begin{matrix}{γ}_{mag} \\ {γ}_{acc} \\ {γ}_{gyro}\end{matrix} ] \qquad ( 33 )$$

### 4. OPERATION OF CENTRAL POINT DERIVATION UNIT 200

FIG. 7 is a flow chart showing the operation of the central point derivation unit 200. A central point derivation process shown in the flow chart is commenced by the CPU 10 executing a state estimation program.

At step S201, the CPU 10 performs an initialization process. Specifically, the CPU 10 removes magnetic data stored in the RAM 20.

Meanwhile, although, in the initialization process according to this embodiment, the CPU 10 deletes all of the magnetic data, the present invention is not limited thereto. For example, the CPU 10 may delete only a predetermined earlier portion of the data accumulated in the RAM 20.

At step S202, the CPU 10 performs a magnetic data accumulation process. Specifically, the CPU 10 stores magnetic data qᵢ sequentially output from the three-dimensional magnetic sensor 70 in the RAM 20. In a case in which N or more magnetic data qᵢ are accumulated in the RAM 20, the CPU 10 advances the process to step S203.

At step S203, the CPU 10 performs a magnetic data distribution decision process. Specifically, the CPU 10 decides whether or not N later magnetic data q₁ to q_{N} (N being a natural number, equal to or greater than 5, indicating a prescribed number of times for measuring magnetic data necessary to derive the coordinates of the central point cₒ at high precision) of the magnetic data accumulated in the RAM 20 through the magnetic data accumulation process of step S202 are proper as data used in a central point calculation process performed at step S204, which will be described below. In a case in which the decision result is affirmative, the CPU 10 advances the process to step S204. On the other hand, in a case in which the decision result is negative, the CPU 10 deletes all of the magnetic data accumulated in the RAM 20, and then returns the process to step S202.

Meanwhile, although, in this embodiment, in a case in which the decision result of the magnetic data distribution decision process is negative, the CPU 10 deletes all of the magnetic data accumulated in the RAM 20, the present invention is not limited thereto. For example, in a case in which the decision result is negative, the CPU 10 may wait for a predetermined period of time without deleting the magnetic data accumulated in the RAM 20, may add a plurality of magnetic data accumulated in the RAM 20 for the above predetermined period of time to the magnetic data accumulated in the RAM 20 at the time of decision, and may perform the decision process again.

At step S204, the CPU 10 performs a central point calculation process. Specifically, on the assumption that the coordinates indicated by the N magnetic data q₁ to q_{N} accumulated in the RAM 20 through the magnetic data accumulation process of step S202 are probably distributed in the vicinity of a certain spherical surface (first spherical surface) S, the CPU 10 calculates coordinates of a central point cO of the spherical surface S.

At step S205, the CPU 10 performs a distortion decision process. Specifically, on the assumption that the coordinates indicated by the N magnetic data q₁ to q_{N} accumulated in the RAM 20 through the magnetic data accumulation process of step S202 are distributed in the vicinity of the surface of a certain three-dimensional figure SD, the CPU 10 decides whether or not the shape of the three-dimensional figure SD and the shape of the spherical surface are approximate to each other to such an extent that the shape of the three-dimensional figure SD and the shape of the spherical surface can be regarded as the same. In a case in which the decision result is affirmative, i.e. in a case in which it is decided that the coordinates indicated by the N magnetic data q₁ to q_{N} are distributed in the vicinity of the surface of the three-dimensional figure SD, the shape of which is approximate to that of the spherical surface, the CPU 10 advances the process to step S206. On the other hand, in a case in which the decision result is negative, i.e. in a case in which it is decided that the three-dimensional figure SD has a greatly distorted shape different from the shape of the spherical surface, the CPU 10 returns the process to step S201.

Meanwhile, although, in the distortion decision process according to this embodiment, in a case in which it is decided that the three-dimensional figure SD and the spherical surface have different shapes, the CPU 10 returns the process to step S201, the present invention is not limited thereto. For example, in a case in which it is decided as the result of the distortion decision process that the three-dimensional FIG. 5D and the spherical surface have different shapes, the CPU 10 may output any message to the display unit 50, and may temporarily stop the process until an instruction from a user of the portable instrument 1 is received to resume the process of step S201.

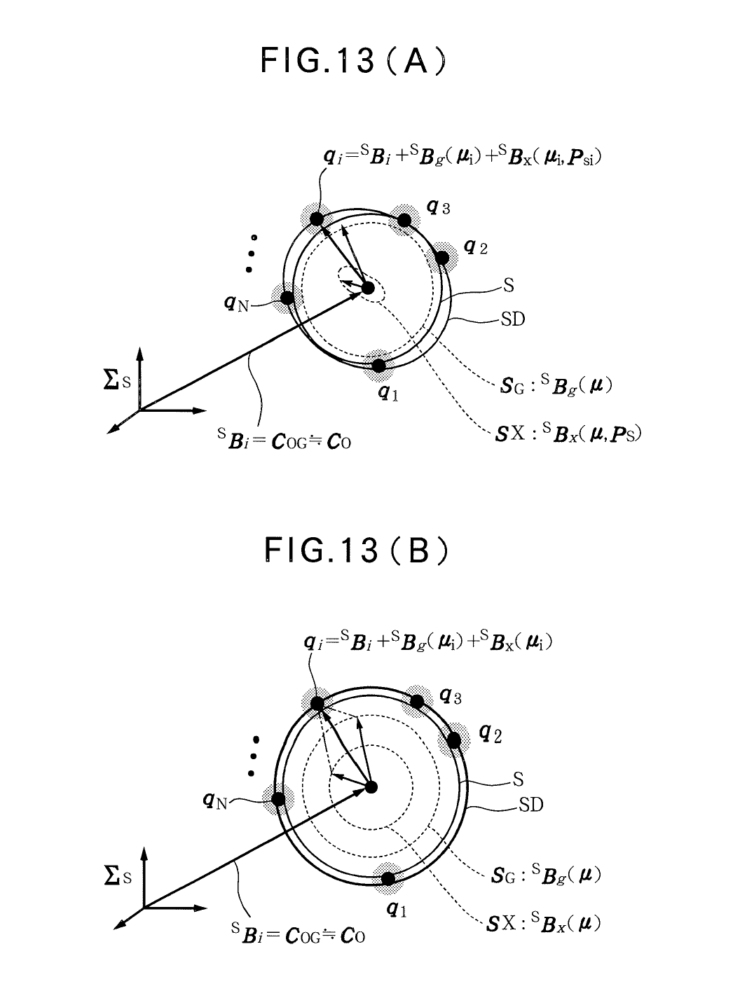

If the user of the portable instrument 1 changes only the posture μ of the portable instrument 1 in a state in which the position P_{S} of the portable instrument 1 (strictly speaking, the position of the three-dimensional magnetic sensor 70) is fixed while holding the portable instrument 1 without swinging the portable instrument 1 so that the position P_{S} of the portable instrument 1 is changed when the N magnetic data q₁ to q_{N} are acquired, it is possible to minimize the influence of the external magnetic field B_{X} (see FIG. 13(B)). In a case in which it is decided at step S205 that the three-dimensional figure SD has a greatly distorted shape different from the shape of the spherical surface, therefore, rotation of the portable instrument 1 in a state in which the position of the portable instrument 1 is fixed may be instructed to the user of the portable instrument 1. The instruction to the user of the portable instrument 1 may be carried out by displaying a picture or a motion picture on the display unit 50 of the portable instrument 1 or by outputting voice.

At step S206, the CPU 10 performs a central point output process. Specifically, the CPU 10 transfers the coordinates of the central point cₒ calculated through the central point calculation process of step S204 to the previously-described state estimation process (see FIG. 5).

The CPU 10 performs steps S201 to S206 as described above, and therefore, the CPU 10 functions as the central point derivation unit 200.

Subsequently, the CPU 10 decides whether or not an end condition for ending the state estimation program is satisfied (step S207). In a case in which the end condition is satisfied, the CPU 10 ends the central point derivation process shown in the flow chart. On the other hand, in a case in which the end condition is not satisfied, the CPU 10 advances the process to step S201.

Meanwhile, although, in this embodiment, in a case in which the end condition is not satisfied at step S207, the CPU 10 advances the process to step S201, the present invention is not limited thereto. For example, in a case in which the end condition of step S207 is not satisfied, the CPU 10 may temporarily stop the process for a predetermined period of time, and may advance the process to step S201 after the lapse of the predetermined period of time. Also, in a case in which the end condition of step S207 is not satisfied, the CPU 10 may decide whether or not it is necessary to generate the coordinates of the central point cₒ based on the observation residual zₖ generated through the state vector update process (step S104) (for example, whether or not norm of the observation residual zₖ is equal to or greater than a threshold value), and, upon determining that it is necessary to generate the coordinates of the central point cₒ, may advance the process to step S201.

Hereinafter, the magnetic data distribution decision process (step S203), the central point calculation process (step S204), and the distortion decision process (step S205) will be described in detail. Meanwhile, the central point calculation process of step S204 will be described first, and then the magnetic data distribution decision process of step S203 will be described for the convenience of description.

### 5. CENTRAL POINT CALCULATION PROCESS

The central point calculation process is a process of separating a magnetic field Bᵢ component from the coordinates indicated by the N magnetic data q₁ to q_{N} using the difference in properties between the internal magnetic field Bᵢ and the geomagnetism B_{g} to calculate the coordinates of the central point cₒ, which are the coordinates becoming a candidate of the offset q_{OFF} of the magnetic sensor.

Hereinafter, the difference in properties between the internal magnetic field Bᵢ and the geomagnetism B_{g}, which is a premise of the central point calculation process will be described in section 5.1, and then the central point calculation process will be described in section 5.2.

[5.1. Properties of Internal Magnetic Field and Geomagnetism]

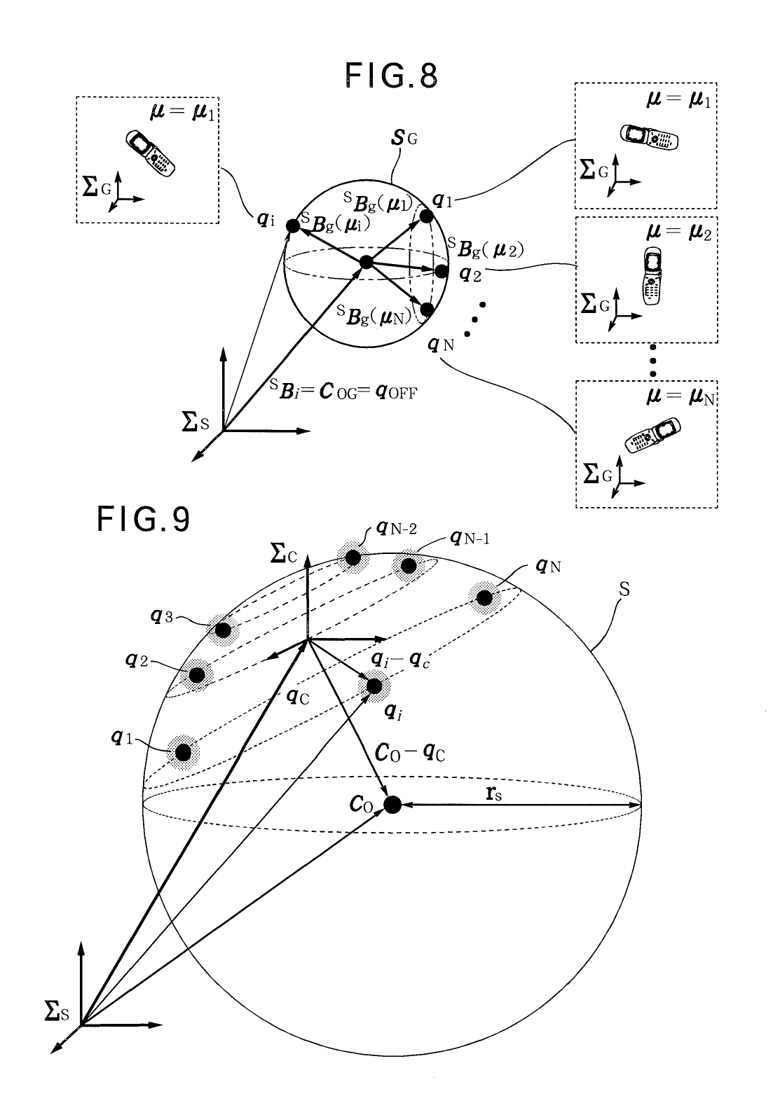

FIG. 8 is a view showing that, in a case in which the three-dimensional magnetic sensor 70 measures the internal magnetic field Bᵢ and the geomagnetism B_{g} while the posture μ is changed into μ₁ to μ_{N}, the N magnetic data q₁ to q_{N} output by the three-dimensional magnetic sensor 70 are plotted in the sensor coordinate system Σ_{S}.

Meanwhile, a superscript S attached to the left upper part of each vector described in FIG. 8 means that the vector is expressed in the sensor coordinate system Σ_{S}.

The internal magnetic field Bᵢ is a magnetic field generated by the part of the portable instrument 1. The internal magnetic field Bᵢ has a uniform direction with respect to the portable instrument 1 and uniform magnitude unless the internal state of the portable instrument 1 is changed. That is, the internal magnetic field Bᵢ is represented as a vector ^{S}Bᵢ having a uniform direction and magnitude, which do not depend upon the position P_{S} and the posture μ of the three-dimensional magnetic sensor 70, in the sensor coordinate system Σ_{S}. Specifically, as shown in FIG. 8, the vector ^{S}Bᵢ representing the internal magnetic field is a vector having the origin of the sensor coordinate system Σ_{S} as the start point and a central point c_{OG} as the end point.

On the other hand, the geomagnetism B_{g} is a magnetic field having a horizontal component directed to a north magnetic pole and a component perpendicular to a magnetic dip direction. The geomagnetism B_{g} is a magnetic field having a uniform direction and uniform magnitude in the ground coordinate system Σ_{G}. In a case in which the posture μ of the portable instrument 1 is changed, therefore, the magnitude of the geomagnetism B_{g} is not changed, but the direction of the geomagnetism B_{g} viewed from the portable instrument 1 is changed. That is, the geomagnetism B_{g} is represented as a vector ^{S}B_{g}(μ) having a direction changed as the posture μ of the portable instrument 1 is changed and uniform magnitude.

The magnetic data q₁ to q_{N} is output as coordinates indicated by a vector representing the sum of the vector ^{S}Bᵢ representing the internal magnetic field and the vector ^{S}B_{g}(μ) representing the geomagnetism in the sensor coordinate system Σ_{S}. Consequently, the coordinates indicated by the magnetic data q₁ to q_{N} in the sensor coordinate system Σ_{S} are distributed on a spherical surface S_{G} having the central point c_{OG} as the center and the magnitude of the geomagnetism B_{g} as the radius. Meanwhile, a measurement value of the three-dimensional magnetic sensor 70 has a measurement error. Strictly speaking, therefore, the coordinates indicated by the magnetic data q₁ to q_{N} are probably distributed in the vicinity of the spherical surface S_{G}.

The coordinates of the central point c_{OG} of the spherical surface S_{G} indicated by the vector ^{S}Bᵢ representing the internal magnetic field and the coordinates indicated by the offset q_{OFF} of the magnetic sensor are the same. Consequently, the offset q_{OFF} of the magnetic sensor is calculated by finding the coordinates of the central point c_{OG} of the spherical surface S_{G} based on the magnetic data q₁ to q_{N}. That is, it is possible to calculate a correct direction and magnitude of the geomagnetism B_{g} by subtracting the coordinates indicated by the offset q_{OFF} of the magnetic sensor from the coordinates indicated by the magnetic data qᵢ.

[5.2. Details of Central Point Calculation Process]

Hereinafter, the central point calculation process of step S204 will be described with reference to FIG. 9. The central point calculation process is a process of calculating coordinates of a central point cₒ of a spherical surface S having a radius r_{S} on the assumption that coordinates indicated by N magnetic data q₁ to q_{N} output by the three-dimensional magnetic sensor 70 are distributed in the vicinity of the spherical surface S.

Meanwhile, the spherical surface S is a spherical surface introduced for the convenience of calculation in the sensor coordinate system Σ_{S} to find the central point of the spherical surface set to have the coordinates indicated by the magnetic data q₁ to q_{N} in the vicinity thereof, and therefore, the spherical surface S is different from the spherical surface S_{G} representing the geomagnetism B_{g}.

In a case in which the three-dimensional magnetic sensor 70 detects only the internal magnetic field Bᵢ and the geomagnetism B_{g}, however, the coordinates indicated by the magnetic data q₁ to q_{N} are distributed in the vicinity of the spherical surface S_{G}. In this case, therefore, the spherical surface S set to have the coordinates indicated by the magnetic data q₁ to q_{N} in the vicinity thereof and the spherical surface S_{G} are almost the same, and the central point cₒ of the spherical surface S and the central point c_{OG} of the spherical surface S_{G} are almost the same. In a case in which the three-dimensional magnetic sensor 70 detects only the internal magnetic field Bᵢ and the geomagnetism B_{g}, therefore, it is possible to calculate the coordinates of the central point c_{OG} of the spherical surface S_{G}, i.e. the offset q_{OFF} of the magnetic sensor, by calculating the coordinates of the central point cₒ of the spherical surface S set to have the coordinates indicated by the magnetic data q₁ to q_{N} in the vicinity thereof.

Hereinafter, a method of calculating the central point cₒ of the spherical surface S will be described in detail. Meanwhile, vectors and coordinates described below are expressed in the sensor coordinate system Σ_{S} if not otherwise specified.

On the assumption that the coordinates indicated by the magnetic data q₁ to q_{N} are present on the spherical surface S having the radius r_{S}, the distance between the coordinates indicated by the magnetic data qᵢ and the central point cₒ of the spherical surface S is r_{S}, and therefore, the following equation (34) is realized. Meanwhile, each element of the coordinates indicated by the magnetic data qᵢ is represented by equation (35), and each element of the coordinates of the central point cₒ is represented by equation (36).

∥qᵢ−cₒ∥₂²=r_{S}²(i=1, . . . , N) (34)

where qᵢ=[qᵢₓq_{iy}q_{iz}]^{T} (35)

cₒ=[c_{Ox}c_{Oy}c_{Oz}]^{T} (36)

Here, a center of gravity q_{C} of the coordinates indicated by the magnetic data q₁ to q_{N} is defined by equation (37). Meanwhile, each element of the center of gravity q_{C} is represented by equation (38). Equation (34) is modified into equation (39) by expressing the coordinates indicated by the magnetic data qᵢ and the coordinates of the central point cₒ as a vector having the center of gravity q_{C} as the start point.

$$\begin{matrix}{q}_{C} = \frac{1}{N} {\sum }_{i = 1}^{N} {q}_{i} & ( 37 ) \\ where {q}_{C} = {[ \begin{matrix}{q}_{cx} & {q}_{cy} & {q}_{cz}\end{matrix} ]}^{T} & ( 38 ) \\ {‖ ( {q}_{i} - {q}_{C} ) - ( {c}_{O} - {q}_{C} ) ‖}_{2}^{2} = {r}_{s}^{2} ( i = 1 , … , N ) & ( 39 )\end{matrix}$$

The result obtained by substituting the coordinates indicated by the magnetic data q₁ to q_{N} into the coordinates indicated by the magnetic data qᵢ of equation (39) is subtracted by the number of the magnetic data, N, to obtain the following equation (40). Also, the difference between equation (39) and equation (40) is taken to obtain the following equation (41).

$$\begin{matrix} \frac{1}{N} {\sum }_{i = 1}^{N} {( {q}_{i} - {q}_{c} )}^{T} ( {q}_{i} - {q}_{c} ) + {( {c}_{o} - {q}_{c} )}^{T} ( {c}_{o} - {q}_{c} ) = {r}_{s}^{2} & ( 40 ) \\ {( {q}_{i} - {q}_{c} )}^{T} ( {c}_{o} - {q}_{c} ) = \frac{1}{2} [ {( {q}_{i} - {q}_{c} )}^{T} ( {q}_{i} - {q}_{c} ) - \frac{1}{N} {\sum }_{i = 1}^{N} {( {q}_{i} - {q}_{c} )}^{T} ( {q}_{i} - {q}_{c} ) ] \\ ( i = 1 , … , N ) & ( 41 )\end{matrix}$$

In this way, equation 34 indicating that the coordinates indicated by the variable qᵢ, which is the magnetic data, are present on the spherical surface S is modified into equation (41). N equations obtained by substituting coordinates indicated by N magnetic data q₁ to q_{N} into the variable qᵢ of equation (41) are expressed as equation (42) using a matrix X. Meanwhile, the matrix X is a matrix of 3×3 represented by equation (43). Also, a vector j is an N-dimensional vector represented by equation (44), and a value R is a value represented by equation (45).

$$\begin{matrix}X ( {c}_{O} - {q}_{C} ) = j & ( 42 ) \\ where X = [ \begin{matrix}{( {q}_{1} - {q}_{C} )}^{T} \\ ⋮ \\ {( {q}_{N} - {q}_{C} )}^{T}\end{matrix} ] & ( 43 ) \\ j = \frac{1}{2} [ \begin{matrix}{( {q}_{1} - {q}_{C} )}^{T} ( {q}_{1} - {q}_{C} ) - R \\ ⋮ \\ {( {q}_{N} - {q}_{C} )}^{T} ( {q}_{N} - {q}_{C} ) - R\end{matrix} ] & ( 44 ) \\ R = \frac{1}{N} {\sum }_{i = 1}^{N} {( {q}_{i} - {q}_{C} )}^{T} ( {q}_{i} - {q}_{C} ) & ( 45 )\end{matrix}$$

In a case in which all of the coordinates indicated by the magnetic data q₁ to q_{N} completely coincide with the spherical surface S having the central point cₒ as the center, equation (42) has a solution. When considering a measurement error of the three-dimensional magnetic sensor 70, however, all of the magnetic data q₁ to q_{N} do not completely coincide with the spherical surface S, and therefore, equation (42) does not have a solution. In order to obtain a presumable solution using a statistical method, therefore, a first spherical error vector δ_{S}, which is a vector absorbing an error represented by equation (46), is introduced. Here, a three-dimensional vector c represented by equation (47) is a variable vector for representing the coordinates of the central point cₒ.

δ_{S}=X(c−q_{C})−j (46)

where c=[cₓc_{y}c_{z}]^{T} (47)

The coordinates indicated by the vector c to minimize norm of the first spherical error vector δ_{S}, i.e. the vector c to minimize (δ_{S})^{T}(δ_{S}), may be presumed as the coordinates of the central point cₒ of the spherical surface S. Here, when an objective function (central point calculation function) f_{S}(c) represented by the following equation (48) is defined, the coordinates indicated by the vector c to minimize the objective function f_{S}(c) have a value presumed as the coordinates of the central point cₒ of the spherical surface S. In a case in which a variance-covariance matrix A represented by equation (50) is regular, the coordinates of the central point cₒ are represented by equation (49).

$$\begin{matrix}\begin{matrix}{f}_{S} ( c ) = {‖ {δ}_{S} ‖}_{2} \\ = {‖ X ( c - {q}_{C} ) - j ‖}_{2}\end{matrix} & ( 48 ) \\ {c}_{O} = {A}^{- 1} {X}^{T} j + {q}_{C} & ( 49 ) \\ where A = {X}^{T} X & ( 50 )\end{matrix}$$

As previously described, in a case in which the three-dimensional magnetic sensor 70 detects only the internal magnetic field Bᵢ and the geomagnetism B_{g}, the spherical surface S and the spherical surface S_{G} representing the geomagnetism B_{g} become almost the same spherical surface, and the central point cₒ of the spherical surface S and the central point c_{OG} of the spherical surface S_{G} become almost the same coordinates. In a case in which the three-dimensional magnetic sensor 70 detects only the internal magnetic field Bᵢ and the geomagnetism B_{g}, therefore, it is possible to adopt the vector indicating the coordinates of the central point cₒ represented by equation (49) as the offset C_{OFF} of the magnetic sensor.

### 6. MAGNETIC DATA DISTRIBUTION DECISION PROCESS

Hereinafter, the magnetic data distribution decision process performed at step S203 will be described.

In the above-described central point calculation process, it is necessary for the coordinates indicated by the magnetic data q₁ to q_{N} to be distributed so that the coordinates indicated by the magnetic data q₁ to q_{N} have three-dimensional dispersion in the sensor coordinate system Σ_{S} in order to calculate the central point cₒ of the spherical surface S. Since the posture μ of the portable instrument 1 (the three-dimensional magnetic sensor 70) is changed as a user of the portable instrument 1 moves the portable instrument 1 while holding the portable instrument 1, however, the posture of the instrument 1 may not be three-dimensionally changed but may be two-dimensionally changed if the movement of the portable instrument 1 is insufficient. In this case, the coordinates indicated by the magnetic data q₁ to q_{N} in the sensor coordinate system Σ_{S} are two-dimensionally distributed without three-dimensional dispersion.

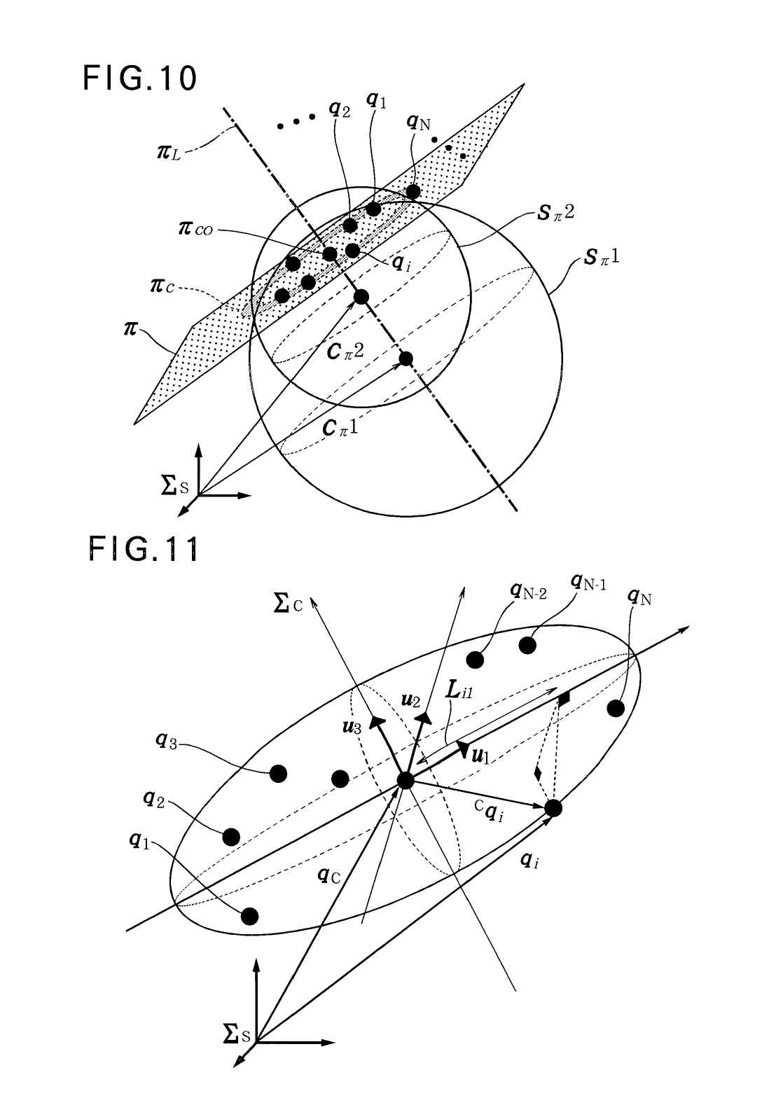

For example, in a case in which the coordinates indicated by the magnetic data q₁ to q_{N} are two-dimensionally distributed in the vicinity of a circle π_{C} on a plane n of the sensor coordinate system Σ_{S} as shown in FIG. 10, the spherical surface S is specified only as a spherical surface having the circle π_{C} as the cross section. The spherical surface having the circle π_{C} as the cross section may be a spherical surface S_{π1} having a central point c_{π1} on a straight line π_{L} perpendicular to the plane n passing through a central point π_{CO} of the circle π_{C} as the center or a spherical surface S_{π2} having a central point c_{π2} on the straight line π_{L} as the center. That is, it is possible to specify that the central point cₒ of the spherical surface S is positioned on the straight line π_{L}; however, it is not possible to concretely specify at which position on the straight line π_{L} the central point c_{S} of the spherical surface S is located. In a case in which the coordinates indicated by the magnetic data q₁ to q_{N} are two-dimensionally distributed, therefore, it is not possible to calculate correct coordinates of the central point cₒ based on the magnetic data q₁ to q_{N}.

In order to calculate the central point cₒ of the spherical surface S based on the magnetic data q₁ to q_{N}, it is necessary for the coordinates indicated by the magnetic data q₁ to q_{N} to be distributed with three-dimensional dispersion in the sensor coordinate system Σ_{S} as shown in FIG. 11. In the magnetic data distribution decision process, the CPU 10 (central point derivation unit 200) decides whether or not the coordinates indicated by the magnetic data q₁ to q_{N} are three-dimensionally distributed using the variance-covariance matrix A represented by equation (50). Hereinafter, properties of the variance-covariance matrix A will be described.

Eigenvalues of the variance-covariance matrix A are set to a maximum eigenvalue λ₁, an intermediate eigenvalue λ₂, and a minimum eigenvalue λ₃ in order of size, and eigenvectors normalized to sizes 1 corresponding to the respective eigenvalues are set to u₁, u₂, and u₃. Also, a vector representing the coordinates indicated by the magnetic data qᵢ in a center of gravity coordinate system Σ_{C} having the above-mentioned center of gravity q_{C} as the origin is represented by ^{c}qᵢ. At this time, the eigenvalue λⱼ (j=1, 2, and 3) is equal to a variance ρ²ⱼ in a direction of the eigenvector uⱼ.

As shown in FIG. 11, the respective eigenvectors u₁, u₂, and u₃ are disposed so that respective eigenvectors u₁, u₂, and u₃ have the origin q_{C} of the center of gravity coordinate system Σ_{C} as the start point. At this time, for example, a case in which j=1 is examined. The eigenvalue λ₁ is equal to a value obtained by averaging a square (Lᵢₗ)² of a length Lᵢₗ obtained by projecting the vector ^{c}qᵢ on the eigenvector u₁ with respect to N magnetic data ^{c}qᵢ (i=1, 2 . . . , and N). That is, the eigenvalue λⱼ represents to what extent the coordinates indicated by the N magnetic data qᵢ are spaced apart from the center of gravity q_{C} in a direction of the eigenvector uⱼ, i.e. how much spread the distribution of the coordinates indicated by the magnetic data q₁ to q_{N} has in the direction of the eigenvector u

The direction of the eigenvector u₃ corresponding to the minimum eigenvalue λ₃ is a direction in which the distribution of the coordinates indicated by the magnetic data q₁ to q_{N} has the least extension, and the minimum eigenvalue λ₃ is an index for indicating a degree of extension in the direction in which the distribution of the coordinates indicated by the magnetic data q₁ to q_{N} has the least extension. In order for the coordinates indicated by the magnetic data q₁ to q_{N} to be three-dimensionally distributed, therefore, the minimum eigenvalue λ₃ may have a value equal to or greater than a predetermined threshold value (an allowable variance value) λ₀.

In the magnetic data distribution decision process, if the minimum eigenvalue λ₃ of the variance-covariance matrix A is equal to or greater than the threshold value λ₀, the central point derivation unit 200 determines that the coordinates indicated by the magnetic data q₁ to q_{N} are sufficiently three-dimensionally distributed, and advances the process to the above-mentioned central point calculation process of step S204. On the other hand, in a case in which the minimum eigenvalue λ₃ is less than the threshold value λ₀, the central point derivation unit 200 determines that the coordinates indicated by the magnetic data q₁ to q_{N} are two-dimensionally distributed without three-dimensional dispersion, and returns the process to the magnetic data accumulation process of step S202.

### 7. DISTORTION DECISION PROCESS

Meanwhile, as shown in FIG. 3, the three-dimensional magnetic sensor 70 may detect the external magnetic field B_{X} generated by the object 2 present outside the portable instrument 1 in addition to the geomagnetism B_{g} and the internal magnetic field Bᵢ. The external magnetic field Bₓ is a nonuniform magnetic field, the direction and magnitude of which are changed depending upon a relative positional relationship between the object 2 and the portable instrument 1.

The central point calculation process described in section 5 calculates the coordinates of the central point cₒ of the spherical surface S, which are candidates of the coordinates indicated by the offset q_{OFF} of the magnetic sensor, on the premise that the three-dimensional magnetic sensor 70 detects only the geomagnetism B_{g} and the internal magnetic field Bᵢ. In a case in which the three-dimensional magnetic sensor 70 detects the nonuniform external magnetic field B_{X} in addition to the geomagnetism B_{g} and the internal magnetic field Bᵢ, therefore, the coordinates of the central point cₒ calculated through the central point calculation process have an error due to the influence of the external magnetic field B_{X}, and a possibility of the coordinates of the central point cₒ being different from the coordinates representing the internal magnetic field Bᵢ, (that is, the offset q_{OFF} of the magnetic sensor) is great. In a case in which a vector indicating the coordinates of the central point cₒ as described above is adopted as the offset q_{OFF} of the magnetic sensor, it is not possible to perform a proper correction process, and therefore, it is not possible for the portable instrument 1 to calculate a correct direction and magnitude of the geomagnetism B_{g}.

In the distortion decision process of step S205, the CPU 10 (central point derivation unit 200) decides whether or not the nonuniform external magnetic field B_{X} is present and evaluates the magnitude of the influence of the external magnetic field B_{X} to determine whether or not it is right to adopt the vector indicating the coordinates of the central point cₒ calculated through the central point calculation process as the offset q_{OFF} of the magnetic sensor.

Hereinafter, properties of the external magnetic field B_{X} to be decided in the distortion decision process will be described in section 7.1, and then the distortion decision process will be described in detail in section 7.2.

[7.1. Properties of External Magnetic Field]

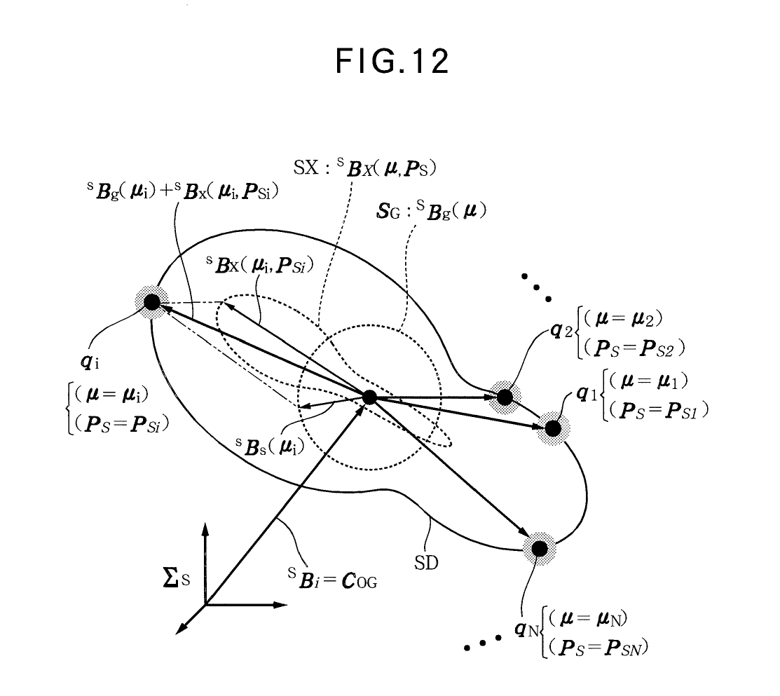

FIG. 12 is a view showing that, when the position P_{S} of the three-dimensional magnetic sensor 70 is changed into P_{S1} to P_{SN}, and, in addition, the posture μ of the three-dimensional magnetic sensor 70 is changed into μ₁ to μ_{N} to measure a magnetic field, the coordinates indicated by the magnetic data q₁ to q_{N} output by the three-dimensional magnetic sensor 70 are plotted in the sensor coordinate system Σ_{S}. Meanwhile, in FIG. 12, it is assumed that the internal magnetic field Bᵢ, the geomagnetism B_{g}, and the external magnetic field Bₓ are present.

The external magnetic field Bₓ is a nonuniform magnetic field, and the direction and magnitude of the external magnetic field Bₓ are changed depending upon a relative positional relationship between the object 2 generating the external magnetic field Bₓ and the portable instrument 1. In a case in which the position P_{S} of the three-dimensional magnetic sensor 70 is changed, therefore, the direction and magnitude of the external magnetic field Bₓ detected by the three-dimensional magnetic sensor 70 are also changed. In the same manner, in a case in which posture μ of the three-dimensional magnetic sensor 70 is changed, therefore, the direction of the external magnetic field B_{X} detected by the three-dimensional magnetic sensor 70 is also changed. That is, the external magnetic field B_{X} is expressed as a vector ^{S}Bₓ(μ, P_{S}), both the direction and magnitude of which are changed depending upon the posture μ and the position P_{S} of the three-dimensional magnetic sensor 70 in the sensor coordinate system Σ_{S}.

The coordinates indicated by the magnetic data q₁ to q_{N} are indicated by a vector representing the sum of a vector ^{S}Bᵢ representing the internal magnetic field, a vector ^{S}B_{g}(μ) representing the geomagnetism, and a vector ^{S}Bₓ(μ, P_{S}) representing the external magnetic field. Consequently, the coordinates indicated by the magnetic data q₁ to q_{N} are distributed in the vicinity of the surface of a three-dimensional figure SD obtained by overlapping a spherical surface S_{G}, representing the end point of the vector ^{S}B_{g}(μ) representing the geomagnetism having the central point c_{OG} as the start point, and a curved surface SX, representing the end point of the vector ^{S}Bₓ(μ, P_{S}) representing the external magnetic field having the central point c_{OG} as the start point.

In a case in which the curved surface SX representing the external magnetic field B_{X} has a distorted shape different from the spherical surface, the three-dimensional figure SD also has a distorted shape different from the spherical surface. In a case in which the coordinates indicated by the magnetic data q₁ to q_{N} are distributed in the vicinity of the surface of the three-dimensional figure SD having the distorted shape different from the spherical surface, the distance between the coordinates indicated by the magnetic data q₁ to q_{N} and the spherical surface S is greatly increased although the spherical surface S is set so as to have the coordinates indicated by the magnetic data q₁ to q_{N} as in the vicinity thereof as possible. In this case, the coordinates indicated by the magnetic data q₁ to q_{N} distributed in the vicinity of the surface of the three-dimensional figure SD are not distributed in the vicinity of the spherical surface S. In the same manner, the coordinates indicated by the magnetic data q₁ to q_{N} are also not distributed in the vicinity of the spherical surface S_{G} representing the geomagnetism B_{g}.

In a case in which the coordinates indicated by the magnetic data q₁ to q_{N} are distributed in the vicinity of the surface of the three-dimensional figure SD having the distorted shape different from the spherical surface, therefore, a possibility of the central point cₒ of the spherical surface S and the central point c_{OG} of the spherical surface S_{G} having different coordinates is great, and it is not possible to adopt a vector indicating the coordinates of the central point cₒ as the offset q_{OFF} of the magnetic sensor (see FIG. 15).

In a case in which the influence of the nonuniform external magnetic field B_{X} is little, and the shape of the three-dimensional figure SD is regarded almost as a spherical surface, however, the spherical surface S set so as to have the coordinates indicated by the magnetic data q₁ to q_{N} in the vicinity thereof and the three-dimensional figure SD can be regarded almost as the same figure, and the central point cₒ of the spherical surface S and the central point c_{oG} of the spherical surface S_{G} representing the geomagnetism B_{g} have almost the same coordinates. In a case in which the shape of the three-dimensional figure SD is regarded almost as a spherical surface, therefore, it is possible to adopt a vector indicating the coordinates of the central point cₒ of the spherical surface S as the offset q_{OFF} of the magnetic sensor. Hereinafter, a case in which the influence of the external magnetic field Bₓ is little will be described in detail with reference to FIG. 13.

FIG. 13(A) shows a case in which the external magnetic field B_{X} is weak.

The three-dimensional figure SD is obtained by overlapping the spherical surface S_{G} representing the geomagnetism B_{g} and the curved surface SX representing the external magnetic field B. In a case in which the external magnetic field B_{X} is weak, and the curved surface SX representing the external magnetic field B_{X} is small, therefore, the three-dimensional figure SD and the spherical surface S_{G} become almost the same figure. At this time, the coordinates indicated by the magnetic data q₁ to q_{N} distributed in the vicinity of the surface of the three-dimensional FIG. 5D can be regarded as also being distributed in the vicinity of the spherical surface S_{G}.

Also, since the shape of the three-dimensional figure SD having the coordinates indicated by the magnetic data q₁ to q_{N} in the vicinity thereof is almost a spherical surface, the spherical surface S set so as to have the coordinates indicated by the magnetic data q₁ to q_{N} in the vicinity thereof and the three-dimensional figure SD become almost the same figure. That is, the three-dimensional figure SD, the spherical surface S_{G}, and the spherical surface S become almost the same figure, and the central point cₒ of the spherical surface S and the central point c_{OG} of the spherical surface S_{G} have almost the same coordinates.

In a case in which the external magnetic field B_{X} is weak as shown in FIG. 13(A), therefore, it is possible to adopt the vector indicating the coordinates of the central point cₒ calculated through the central point calculation process as the offset q_{OFF} of the magnetic sensor.

Meanwhile, even in a case in which the nonuniform external magnetic field B_{X} is strong as shown in FIG. 13(B), the shape of the three-dimensional figure SD may be regarded almost as a spherical surface.

For example, even in a case in which the nonuniform external magnetic field B_{X} is present but in a case in which the user of the portable instrument 1 changes only the posture p of the portable instrument 1 in a state in which the position P_{S} of the portable instrument 1 (strictly speaking, the position of the three-dimensional magnetic sensor 70) is fixed while holding the portable instrument 1 without swinging the portable instrument 1 so that the position P_{S} of the portable instrument 1 is changed when N magnetic data q₁ to q_{N} are acquired, the external magnetic field B_{X} is expressed as a vector ^{S}Bₓ(μ), only the direction of which is changed depending upon the posture μ of the three-dimensional magnetic sensor 70 and the magnitude of which is uniform in the sensor coordinate system Σ_{S}. In this case, the shape of the curved surface SX representing the external magnetic field B_{X} becomes a spherical surface having the central point c_{OG} as the center, and therefore, the shape of the three-dimensional figure SD, obtained by overlapping the spherical surface S_{G} and the curved surface SX, also becomes almost a spherical surface. Also, the three-dimensional figure SD is a figure obtained by overlapping the spherical surface S_{G} having the central point c_{OG} as the center and the curved surface SX having the shape of the spherical surface having the central point c_{OG} as the center with the central point c_{OG} as the center, and therefore, the central point of the spherical surface represented by the three-dimensional figure SD almost coincides with the central point c_{OG} of the spherical surface S_{G}. In a case in which the shape of the three-dimensional figure body SD is almost the spherical surface as previously described, the spherical surface S set so as to have the coordinates indicated by the magnetic data q₁ to q_{N} in the vicinity thereof and the three-dimensional figure SD become almost the same figure. Consequently, the central point cₒ of the spherical surface S and the central point c_{OG} of the spherical surface S_{G} have almost the same coordinates.

In a case in which the external magnetic field B_{X} is detected as a vector having uniform magnitude as shown in FIG. 13(B), therefore, it is possible to adopt the vector indicating the coordinates of the central point cₒ calculated through the central point calculation process as the offset q_{OFF} of the magnetic sensor.

In a case in which the influence of the nonuniform external magnetic field B_{X} is great as described above, i.e. in a case in which the three-dimensional figure SD has a distorted shape different from the spherical surface, it is not possible adopt the vector indicating the coordinates of the central point cₒ calculated through the central point calculation process as the offset q_{OFF} of the magnetic sensor.

On the other hand, in a case in which the shape of the three-dimensional figure SD is regarded almost as a spherical surface, for example, in a case in which the nonuniform external magnetic field B_{X} is weak or in a case in which the three-dimensional magnetic sensor 70 detects the nonuniform external magnetic field B_{X} as a vector having uniform magnitude, it is possible to adopt the vector indicating the coordinates of the central point cₒ of the spherical surface S as the offset q_{OFF} of the magnetic sensor.

[7.2. Details of Distortion Decision Process]

Hereinafter, the distortion decision process of step S205 will be described in detail with reference to FIGS. 13 to 15.

In the above-described central point calculation process, it was assumed that the coordinates indicated by the magnetic data q₁ to q_{N} are distributed in the vicinity of the spherical surface S represented by equation (34). In the distortion decision process, which is described in this section, on the other hand, it is assumed that the coordinates indicated by the magnetic data q₁ to q_{N} are distributed in the vicinity of the surface of a three-dimensional figure SD having a distorted shape different from the spherical surface S.

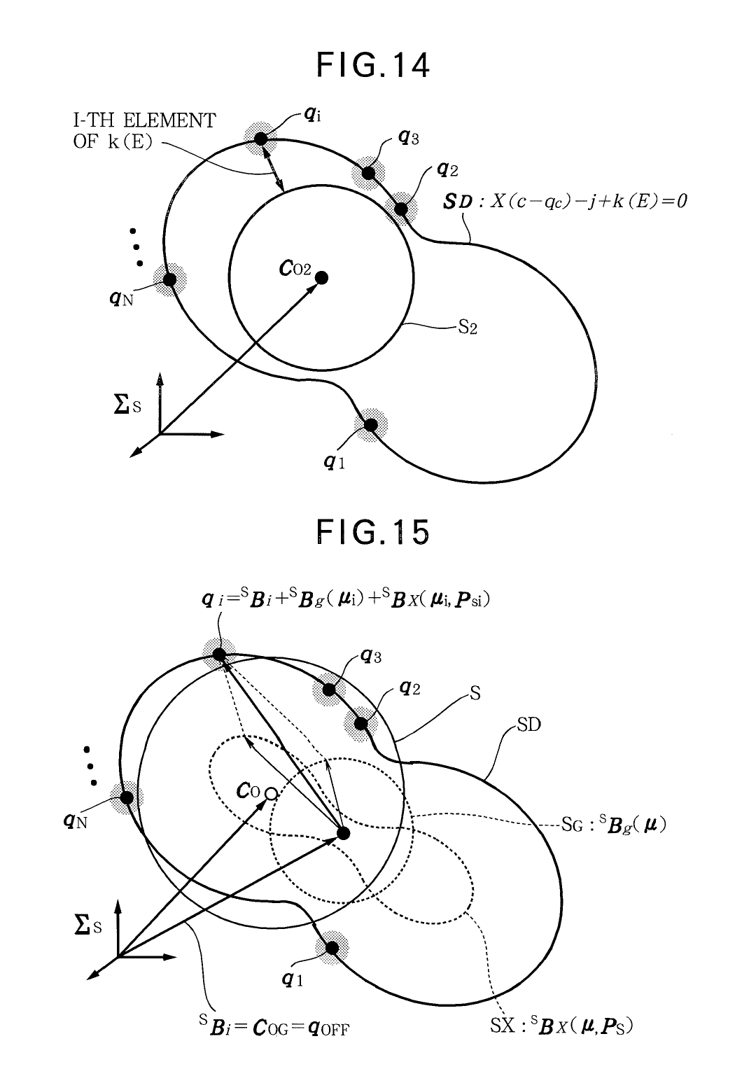

The three-dimensional figure SD is represented by equation (51). As shown in FIG. 14, the three-dimensional figure SD represented by equation (51) is obtained by adding a component X(c-q_{C})-j representing the spherical surface to a distortion error vector k(E) of an N-dimensional vector represented by equation (52). Meanwhile, a subscript N attached to the right lower part of 0_{N} present at the right side of equation (51) represents a dimension of a zero vector. Also, a distortion evaluation matrix E represented by equation (53) is a symmetric matrix of 3×3.

Meanwhile, the spherical surface indicated by the component X(c-q_{C})-j present in equation (51) and the spherical surface S calculated by the central point calculation unit do not necessarily represent the same figure in the sensor coordinate system Σ_{S}. Hereinafter, therefore, the spherical surface represented as the component X(c-q_{C})-j present in equation (51) will be referred to as a spherical surface (second spherical surface) S₂, and a central point of the spherical surface S₂ will be referred to as a central point (central point of the second spherical surface) c_{O2}. Also, although a vector c used in equation (51) is a three-dimensional vector represented by equation (47), the vector c is used as a variable vector for calculating coordinates indicated by the central point c_{O2} in this section.

The distortion decision process evaluates the magnitude of the component k(E) representing distortion of equation (51) to evaluate to what extent the shape of the three-dimensional figure SD and the shape of the spherical surface S₂ are different from each other.

$$\begin{matrix}X ( c - {q}_{C} ) + k ( E ) - j - {O}_{N} & ( 51 ) \\ where k ( E ) = [ \begin{matrix}{( {q}_{1} - {c}_{0} )}^{T} E ( {q}_{1} - {c}_{O} ) \\ ⋮ \\ {( {q}_{N} - {c}_{0} )}^{T} E ( {q}_{N} - {c}_{O} )\end{matrix} ] & ( 52 ) \\ E = [ \begin{matrix}{e}_{11} & {e}_{12} & {e}_{13} \\ {e}_{12} & {e}_{22} & {e}_{23} \\ {e}_{13} & {e}_{23} & {e}_{33}\end{matrix} ] & ( 53 )\end{matrix}$$

An i-th line element ke(qᵢ-cₒ) of the elements constituting the distortion error vector k(E) is given by substituting a vector (qᵢ-cₒ) representing the magnetic data qᵢ with the central point cₒ as the start point into a function ke(p) represented by the following equation (54). The function ke(p) is a function expressed in a quadratic form having the distortion evaluation matrix E represented by equation (53) as a coefficient matrix and three elements of a vector p represented by equation (55) as variables. That is, the function ke(p) indicates the inner product of the vector p and a vector Ep obtained by converting the vector p using the distortion evaluation matrix E.

Consequently, the i-th line element ke(qᵢ-cₒ) of the distortion error vector k(E) is the inner product of the vector (qᵢ-cₒ) representing the coordinates of the magnetic data qᵢ with the central point cₒ of the spherical surface S as the start point and a vector E(qᵢ-cₒ) obtained by converting the vector (qᵢ-cₒ) using the distortion evaluation matrix E.

ke(p)=p^{T}Ep (54)

where p=[pₓp_{y}p_{z}]^{T} (55)

Meanwhile, when considering a measurement error of the three-dimensional magnetic sensor 70, all of the coordinates indicated by the magnetic data q₁ to q_{N} are not present at positions completely coinciding with the three-dimensional figure SD with the result that equation (51) does not have a solution. In order to obtain a presumable solution using a statistical method, therefore, a solid error vector δ_{SD}, which is a vector absorbing an error represented by equation (56), is introduced. The solid error vector δ_{SD} is obtained by adding a second spherical error vector δ_{S2} to the distortion error vector k(E). Meanwhile, the second spherical error vector δ_{S2} is a component corresponding to the component X(c-q_{c})-j representing the spherical surface of equation (51), which will be described in detail below.

The solid error vector δ_{SD} is an N-dimensional vector indicating errors between the coordinates indicated by the magnetic data q₁ to q_{N} and the surface of the three-dimensional figure SD. The three-dimensional figure SD having the coordinates indicated by the magnetic data q₁ to q_{N} in the vicinity of the surface thereof is expressed based on the vector c to minimize norm of the solid error vector δ_{SD} and the distortion evaluation matrix E, i.e. the vector c to minimize an objective function (distortion evaluation function) f_{SD}(E, c) represented by equation (57) and the distortion evaluation matrix E.

The distortion decision process is a process of evaluating the magnitude of the influence of the distortion error vector k(E) in the shape of the three-dimensional FIG. 5D based on a distortion evaluation value g_{D}(E) represented by equation (58) and equation (59), which will be described below. It is possible to know to what extent the shape of the three-dimensional figure SD and the shape of the spherical surface S are different from each other by evaluating the magnitude of the influence of the distortion error vector k(E) in the shape of the three-dimensional figure SD.

$$\begin{matrix}\begin{matrix}{δ}_{SD} = {δ}_{S 2} + k ( E ) \\ = X ( c - {q}_{C} ) + k ( E ) - j\end{matrix} & ( 56 ) \\ \begin{matrix}{f}_{SD} ( E , c ) = {‖ {δ}_{SD} ‖}_{2} \\ = {‖ X ( c - {q}_{C} ) + k ( E ) - j ‖}_{2}\end{matrix} & ( 57 )\end{matrix}$$

Hereinafter, properties of the solid error vector δ_{SD} represented by equation (56) will be described while being compared with the properties of the first spherical error vector δ_{S} represented by equation (46).

First, the first spherical error vector δ_{S} is a vector for absorbing errors between the coordinates indicated by the magnetic data q₁ to q_{N} and the spherical surface S. A first line element to an N-th line element constituting the first spherical error vector δ_{S} are independent variables. In a case in which errors between the coordinates indicated by the magnetic data q₁ to q_{N} and the spherical surface S are absorbed by the first spherical error vector δ_{S}, therefore, N errors between the coordinates indicated by the magnetic data q₁ to q_{N} and the spherical surface S become values independently set without restriction. That is, the N errors represented by the first spherical error vector δ_{S} are independently probably set. All of the N errors are white noise which is symmetric and is not dependent on direction.

That is, the central point calculation process is a process of expressing the errors between the coordinates indicated by the magnetic data q₁ to q_{N} and the spherical surface S using the first spherical error vector δ_{S}, which is white noise, and finding the coordinates of the central point cₒ of the spherical surface S to minimize the first spherical error vector δ_{S}.

On the other hand, the solid error vector δ_{SD} is a vector represented by the sum of the second spherical error vector δ_{S2} and the distortion error vector k(E) for absorbing errors between the coordinates indicated by the magnetic data q₁ to q_{N} and the three-dimensional figure SD.

In the same manner as the first spherical error vector δ_{S}, the second spherical error vector δ_{S2} is a vector present in the right side of equation (46) for expressing the errors between the coordinates indicated by the magnetic data q₁ to q_{N} and the spherical surface S₂ as white noise.

On the other hand, the distortion error vector k(E) is a vector having the function ke(p), configured in a quadratic form having three variables, represented by equation (54) as each element. The quadratic form having three variables is a function in which variables consist of quadratic terms. Various curved surfaces in the three-dimensional space, such as a straight line, a plane, a cylindrical surface, a spherical surface, an ellipsoid, a conical surface, a hyperboloid of one sheet, a hyperboloid of two sheets, and various paraboloids may be represented. Consequently, the distortion error vector k(E) does not express N errors between the coordinates indicated by the magnetic data q₁ to q_{N} and the spherical surface S₂ as independent values but expresses all of the N errors as values having a restriction that the N errors are present on a curved surface in a three-dimensional space represented by the same function ke(p).

In this way, the solid error vector δ_{SD} separately expresses the N errors between the coordinates indicated by the magnetic data q₁ to q_{N} and the spherical surface S₂ as the second spherical error vector δ_{S2}, which is white noise, and the distortion error vector k(E) having a property of distortion from the spherical surface S₂ due to a smoothly curved surface.

Hereinafter, the influence of the distortion error vector k(E) in the shape of the three-dimensional figure SD and determination as to whether or not it is right to adopt the vector indicating the coordinates of the central point cₒ of the spherical surface S calculated through the central point calculation process as the offset q_{OFF} of the magnetic sensor will be described with reference to FIGS. 13 and 15.

FIGS. 13(A) and 13(B) show a case in which the influence of the distortion error vector k(E) in the shape of the three-dimensional figure SD is little. In a case in which the influence of the distortion error vector k(E) is little, the magnitude of the distortion error vector k(E) is small, and therefore, the case in which the influence of the distortion error vector k(E) is little means a case in which equation (42) representing the spherical surface S is regarded as also being realized if equation (51) representing the three-dimensional figure SD is realized. That is, in a case in which the influence of the distortion error vector k(E) is little, the three-dimensional figure SD obtained by minimizing the objective function f_{SD}(E, c) set by equation (57) and the spherical surface S obtained by minimizing the objective function f_{S}(c) set by equation (48) become almost the same. In a case in which the shape of the three-dimensional figure SD is regarded as the spherical surface as described above, the coordinates indicated by the magnetic data q₁ to q_{N} are distributed in the vicinity of the surface of the three-dimensional figure SD and, at the same time, can be regarded as also being distributed in the vicinity of the spherical surface S. Also, the central point of the spherical surface represented by the three-dimensional figure SD almost coincides with the central point c_{OG} of the spherical surface S_{G}, and therefore, the central point cₒ of the spherical surface S and the central point c_{OG} of the spherical surface S_{G} have almost the same coordinates. In a case in which the influence of the distortion error vector k(E) is little, therefore, it is possible to adopt the vector indicating the coordinates of the central point cₒ of the spherical surface S as the offset q_{OFF} of the magnetic sensor. Meanwhile, in a case in which the distortion evaluation matrix E becomes a zero matrix, the distortion error vector k(E) also becomes a zero vector. Consequently, equation (48) and equation (57) become equal to each other, and therefore, the three-dimensional figure SD and the spherical surface S become completely the same figure.

FIG. 15 shows a case in which the influence of the distortion error vector k(E) is great.

The case in which the influence of the distortion error vector k(E) is great indicates a case in which, although the spherical surface S₂ is set so as to have the coordinates indicated by the magnetic data q₁ to q_{N} as in the vicinity thereof as possible, it is not possible to absorb errors between the coordinates indicated by the magnetic data q₁ to q_{N} and the spherical surface S₂ using the second spherical error vector δ_{S2}, and therefore, it is necessary to absorb the errors using the distortion error vector k(E) representing smooth distortion from the spherical surface S₂. That is, in this case, the three-dimensional figure SD obtained by minimizing the objective function f_{SD}(E, c) has a distorted shape greatly different from the shape of the spherical surface S obtained by minimizing the objective function f_{S}(c). In a case in which the shape of the three-dimensional figure SD is a distorted shape different from that of the spherical surface as described above, the coordinates indicated by the magnetic data q₁ to q_{N} distributed in the vicinity of the surface of the three-dimensional figure SD cannot be regarded as being distributed in the vicinity of the spherical surface S. The central point calculation process is a process of calculating the coordinates of the central point cₒ as the candidate of the offset q_{OFF} of the magnetic sensor on the premise that the coordinates indicated by the magnetic data q₁ to q_{N} are present in the vicinity of the spherical surface S. Consequently, the central point cₒ of the spherical surface S not having the coordinates indicated by the magnetic data q₁ to q_{N} in the vicinity thereof does not mean the offset q_{OFF} of the magnetic sensor. In this case, therefore, it is not possible to adopt the vector indicating the coordinates of the central point cₒ as the offset q_{OFF} of the magnetic sensor.

In a case in which the influence of the distortion error vector k(E) in the shape of the three-dimensional figure SD is little as described above, the coordinates indicated by the magnetic data q₁ to q_{N} distributed on the three-dimensional figure SD can be regarded as also being distributed on the spherical surface S, and therefore, it is possible to adopt the vector indicating the coordinates of the central point cₒ of the spherical surface S calculated by the central point calculation unit as the offset q_{OFF} of the magnetic sensor. On the other hand, in a case in which the influence of the distortion error vector k(E) in the shape of the three-dimensional figure SD is great, the coordinates of the central point cₒ have incorrect values with errors, and therefore, it is necessary to prevent the vector indicating the coordinates of the central point cₒ from being adopted as the offset q_{OFF} of the magnetic sensor.

Hereinafter, a method of evaluating the magnitude of the influence of the distortion error vector k(E) in the shape of the three-dimensional figure SD will be described.

Here, the distortion evaluation value g_{D}(E) represented by equations (58) and (59) is defined as an evaluation value for evaluating the magnitude of the influence of the distortion error vector k(E) in the shape of the three-dimensional figure SD. The distortion evaluation value g_{D}(E) is an absolute value of a maximum eigenvalue λ_{E1} having the maximum absolute value (norm of the distortion evaluation matrix E), which is one of the three eigenvalues of the distortion evaluation matrix E.

If the distortion evaluation value g_{D}(E) is a small value equal to or less than a predetermined threshold value (allowable distortion value) δₒ, the three-dimensional FIG. 5D and the spherical surface S₂ can be regarded as the same figure, and therefore, the coordinates indicated by the magnetic data q₁ to q_{N} distributed in the vicinity of the surface of the three-dimensional figure SD can also be regarded as being distributed in the vicinity of the spherical surface S. Also, it is possible to adopt the vector indicating the coordinates of the central point cₒ of the spherical surface S obtained through the central point calculation process as the offset C_{OFF} of the magnetic sensor.

g_{D}(E)==|λ_{E1}|=∥E∥₂ (58)

where f_{SD}(E,c)→Min (59)

Hereinafter, a method of finding the distortion evaluation value g_{D}(E) will be described.

First, the function ke(p) represented by equation (54) is a function expressed in a quadratic form, and therefore, the function ke(p) can be expressed as the inner product of vectors as represented by the following equation (60). Also, the i-th line element ke(qᵢ-cₒ) of the distortion error vector k(E) is a value obtained by substituting the vector (qᵢ-cₒ) into the function ke(p), and therefore, the i-th line element ke(qᵢ-cₒ) is represented by equation (61) using a six-dimensional vector ke₂(i) represented by equation (62) and a six-dimensional vector e_{E} in which components of the distortion evaluation matrix E are arranged as represented by equation (63).

$$\begin{matrix}\begin{matrix}ke ( p ) = {e}_{11} {p}_{x}^{2} + {e}_{22} {p}_{y}^{2} + {e}_{33} {p}_{z}^{2} + 2 {e}_{12} {p}_{x} {p}_{y} + 2 {e}_{13} {p}_{x} {p}_{z} + 2 {e}_{23} {p}_{y} {p}_{z} \\ = {[ \begin{matrix}{p}_{x}^{2} \\ {p}_{y}^{2} \\ 2 {p}_{x} {p}_{y} \\ {p}_{z}^{2} \\ 2 {p}_{y} {p}_{z} \\ 2 {p}_{x} {p}_{z}\end{matrix} ]}^{T} [ \begin{matrix}{e}_{11} \\ {e}_{22} \\ {e}_{12} \\ {e}_{33} \\ {e}_{23} \\ {e}_{13}\end{matrix} ]\end{matrix} & ( 60 ) \\ ke ( {q}_{i} - {c}_{O} ) = {{ke}_{2} ( i )}^{T} {e}_{E} ( i = 1 , … , N ) & ( 61 ) \\ where {ke}_{2} ( i ) = [ \begin{matrix}{( {q}_{ix} - {c}_{Ox} )}^{2} \\ {( {q}_{iy} - {c}_{Oy} )}^{2} \\ 2 ( {q}_{ix} - {c}_{Ox} ) ( {q}_{iy} - {c}_{Oy} ) \\ {( {q}_{iz} - {c}_{Oz} )}^{2} \\ 2 ( {q}_{iy} - {c}_{Oy} ) ( {q}_{iz} - {c}_{Oz} ) \\ 2 ( {q}_{ix} - {c}_{Ox} ) ( {q}_{iz} - {c}_{Oz} )\end{matrix} ] ( i = 1 , … , N ) & ( 62 ) \\ {e}_{E} = {[ \begin{matrix}{e}_{11} & {e}_{22} & {e}_{12} & {e}_{33} & {e}_{23} & {e}_{13}\end{matrix} ]}^{T} & ( 63 )\end{matrix}$$

Here, a matrix X₂ represented by equation (64) is introduced. The matrix X₂ is a matrix of N×9 generated by arranging a vector obtained by transposing the six-dimensional vector ke₂(i) represented by equation (62) and a vector obtained by transposing a three-dimensional vector (qᵢ-q_{c}) at each row.

$${X}_{2} = [ \begin{matrix}{{ke}_{2} ( 1 )}^{T} & {( {q}_{1} - {q}_{C} )}^{T} \\ {{ke}_{2} ( 2 )}^{T} & {( {q}_{2} - {q}_{C} )}^{T} \\ ⋮ & ⋮ \\ {{ke}_{2} ( N )}^{T} & {( {q}_{N} - {q}_{C} )}^{T}\end{matrix} ] \qquad ( 64 )$$

The objective function f_{SD}(E, c) represented by equation (57) can be modified into an objective function g_{SD}(e) represented by equation (65) using the matrix X₂ represented by equation (64). Meanwhile, a vector e is a nine-dimensional vector in which the six-dimensional vector e_{E} represented by equation (63) and a three-dimensional vector eₓ represented by equation (67) are arranged as represented by the following equation (66). Also, the vector eₓ represented by equation (67) is a vector obtained by subtracting the center of gravity g_{c} represented by equation (37) from the variable vector represented by equation (47).

$$\begin{matrix}{g}_{SD} ( e ) = {‖ {X}_{2} e - j ‖}_{2} & ( 65 ) \\ where e = [ \begin{matrix}{e}_{E} \\ {e}_{X}\end{matrix} ] & ( 66 ) \\ here {e}_{X} = c - {q}_{C} & ( 67 )\end{matrix}$$

A solution e=eₒ to minimize the objective function g_{SD}(e) represented by equation (65) is found by applying a Gauss elimination method or a Cholesky factorization method to a simultaneous equation represented by the following equation (68). Meanwhile, equation (68) is a simultaneous equation calculated by applying a least squares method to equation (65).

(X₂^{T}X₂)e₀=X₂^{T}j (68)

The distortion evaluation matrix E of equation (53) is restored based on the solution eₒ obtained as described above. Also, the distortion evaluation value g_{D}(E) represented by equation (58), i.e. the norm of the distortion evaluation matrix E, is found, and it is decided whether or not the distortion evaluation value g_{D}(E) is equal to or less than the threshold value δₒ. Meanwhile, the norm of the distortion evaluation matrix E is equal to an absolute value of the eigenvalue λ_{E1} having the maximum absolute value, which is one of the three eigenvalues of the distortion evaluation matrix E, and therefore, it is possible to find the norm of the distortion evaluation matrix E using a Jacobi method or a power method.

Also, in a case in which the distortion evaluation value g_{D}(E) is equal to or less than the threshold value λₒ, the central point derivation unit 200 advances the process to the central point output process of step S206. On the other hand, in a case in which the distortion evaluation value g_{D}(E) is greater than the threshold value δₒ, the central point derivation unit 200 returns the process to the initialization process of step S201.

### 8. CENTRAL POINT OUTPUT PROCESS

The central point output process of step S206 is performed in a case in which it is decided at the distortion decision process that the distortion evaluation value g_{D}(E) is equal to or less than the threshold value δₒ. In the central point output process, the CPU 10 (central point derivation unit 200) outputs the coordinates of the central point cₒ of the spherical surface S calculated through the central point calculation process and supplies the output coordinates to the state estimation unit 100.

Although, in this embodiment, the central point derivation unit 200 outputs the coordinates of the central point cₒ of the spherical surface S, the central point derivation unit 200 may output the coordinates of the central point c_{O2} of the spherical surface _{S2}. This is because, in a case in which the distortion evaluation value g_{D}(E) is equal to or less than the threshold value δₒ, the central point cₒ of the spherical surface S calculated through the central point calculation process and the central point c_{O2} of the spherical surface S₂ have almost the same coordinates, and therefore, the vector indicating the central point cₒ and the vector indicating the central point c_{O2} can be adopted as the offset c_{OFF} of the magnetic sensor.

Meanwhile, the coordinates of the central point c_{O2} of the spherical surface S₂ are obtained by substituting a part of the solution eₒ to minimize the objective function g_{SD}(e) corresponding to eₓ of equation (66) into equation (67).

### 9. CONCLUSION

As described above, the state estimation apparatus according to this embodiment, including the central point derivation unit 200 and the state estimation unit 100 including the Kalman filter operation unit 120, overwrites the offset estimation value qₒ of the magnetic sensor, which is one of the elements of the state vector xₖ used for the Kalman filter operation unit 120 to perform the Kalman filter operation, using the coordinates of the central point cₒ output by the central point derivation unit 200 to perform the Kalman filter operation. As previously described, it is not possible to formalize time-based change of the offset estimation value qₒ of the magnetic sensor in the state transition model of the Kalman filter, and the state vector xₖ by the Kalman filter is affected by the state vector xₖ before update. For this reason, the offset estimation value qₒ of the magnetic sensor may greatly deviate from the real value (offset q_{OFF} of the magnetic sensor). In this case, it is not possible for the state estimation apparatus to correctly estimate the state of the system, and therefore, it is not possible to calculate the direction of the geomagnetism B_{g} and the posture μ of the portable instrument 1 based on the state variable calculated by the state estimation apparatus.

On the other hand, the Kalman filter operation unit 120 according to this embodiment overwrites the offset estimation value qₒ of the magnetic sensor, which is one of the elements of the state vector xₖ, using the coordinates of the central point cₒ output by the central point derivation unit 200 (the state variable overwriting process performed at step S103). As previously described, the coordinates of the central point cₒ are calculated based on the magnetic data q₁ to q_{N} output from the three-dimensional magnetic sensor 70 for a relatively short period of time. That is, it is possible for the vector indicating the coordinates of the central point cₒ to correctly represent the offset q_{OFF} of the magnetic sensor after change even in a case in which the offset a q_{OFF} of the magnetic sensor is suddenly and greatly changed.

The offset estimation value qₒ of the magnetic sensor is overwritten using the coordinates of the central point cₒ as described above, thereby preventing the state vector xₖ from having a value greatly different from the real value. In addition, it is possible for the portable instrument 1 to calculate a correct direction and magnitude of the geomagnetism B_{g} based on the state vector xₖ.

Also, the central point derivation unit 200 according to this embodiment performs the magnetic data distribution decision process, before performing the central point calculation process, to decide whether or not the magnetic data q₁ to q_{N} used in the central point calculation process are proper to perform the central point calculation process. As a result, the central point derivation unit 200 grasps a degree of three-dimensional dispersion of the distribution of the coordinates indicated by the magnetic data q₁ to q_{N} and, in a case in which the coordinates indicated by the magnetic data q₁ to q_{N} have a planar distribution, does not perform the central point calculation process. Consequently, it is possible to prevent the coordinates of an incorrect central point cₒ (central point cₒ different from the real value) from being calculated based on the magnetic data q₁ to q_{N} which have a planar distribution, thereby achieving low power consumption according to prevention of an unnecessary operation process.

Also, the central point derivation unit 200 according to this embodiment performs the distortion decision process, after performing the central point calculation process, to decide whether or not the coordinates of the central point cₒ of the spherical surface S obtained through the central point calculation process are an improper value (value different from the real value) affected by the external magnetic field Bₓ. As a result, it is possible to prevent output of the coordinates of the improper central point cₒ (central point cₒ that cannot be regarded as the offset q_{OFF} of the magnetic sensor) affected by the external magnetic field B.

In this way, the central point derivation unit 200 according to this embodiment outputs only the coordinates of the central point cₒ approximate to the real value that can be regarded as the offset q_{OFF} of the magnetic sensor through the magnetic data distribution decision process and the distortion decision process. Also, the Kalman filter operation unit 120 overwrites the offset estimation value qₒ of the magnetic sensor using the coordinates of the central point cₒ approximate to the real value, and therefore, it is possible to update the state vector xₖ to a correct value more approximate to the real value. Consequently, it is possible for the portable instrument 1 according to this embodiment to stably calculate a correct value of the geomagnetism B_{g} based on the state vector xₖ calculated by the state estimation apparatus.

### B. Modifications

The present invention is not limited to the above-described embodiment but may be modified as follows. Also, two or more of the following modifications can be properly combined.

(1) First Modification

Although, in the above-described embodiment, the Kalman filter operation unit 120 overwrites the component representing the offset estimation value qₒ of the magnetic sensor, which is one of the components of the state vector xₖ, using the coordinates of the central point cₒ output from the central point derivation unit 200 to perform the Kalman filter operation, the present invention is not limited thereto. The Kalman filter operation may be performed without overwriting the state vector xₖ using the coordinates of the central point cₒ.

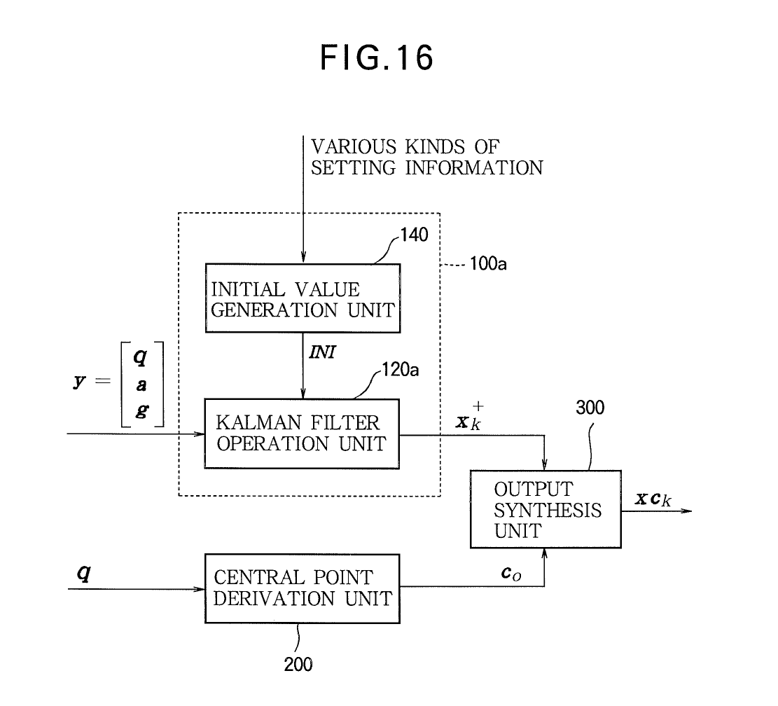

FIG. 16 is a functional block diagram showing a function realized by a CPU 10 of a state estimation apparatus according to the first modification executing a state estimation program according to the first modification.

As shown in FIG. 16, the state estimation apparatus according to the first modification is identical in construction to the state estimation apparatus according to the embodiment except that the state estimation apparatus according to the first modification includes an output synthesis unit 300 and a state estimation unit 100a in place of the state estimation unit 100. The state estimation unit 100a is identical in construction to the state estimation unit 100 except that the state estimation unit 100a includes a Kalman filter operation unit 120a in place of the Kalman filter operation unit 120. The Kalman filter operation unit 120a operates in the same manner as the Kalman filter operation unit 120 except that the Kalman filter operation unit 120a does not overwrite the state vector xₖ using the coordinates of the central point cₒ.

The output synthesis unit 300 outputs a state vector xcₖ based on a state vector x⁺ₖ after update output by the Kalman filter operation unit 120a and the coordinates of the central point cₒ output from the central point derivation unit 200.

In the same manner as the state vector xₖ, the state vector xcₖ is a vector having a posture μ, strength r of geomagnetism, a magnetic dip φ of the geomagnetism, angular velocity ω, offset estimation value gₒ of the angular velocity sensor, and offset estimation value qₒ of the magnetic sensor as components. In the state vector xcₖ, a period from an initial state (time k=0) until the central point derivation unit 200 outputs the coordinates of the central point cₒ is set to the same value as the state vector xₖ. On the other hand, after the central point derivation unit 200 outputs the coordinates of the central point cₒ, the offset estimation value qₒ of the magnetic sensor, which is one of the components constituting the state vector xcₖ, is set to the same value as the coordinates of the central point cₒ.

The Kalman filter operation unit 120a integrates outputs of three sensors, such as a three-dimensional magnetic sensor 70, a three-dimensional acceleration sensor 80, and a three-dimensional angular velocity sensor 90, to estimate various state variables, and therefore, it is possible to calculate the offset estimation value qₒ of the magnetic sensor at high speed. On the other hand, the central point derivation unit 200 calculates the coordinates of the central point cₒ based on N magnetic data q₁ to q_{N} with the result that it takes a predetermined time until the coordinates of the central point cₒ are calculated; however, it is decided whether or not the coordinates of the central point cₒ are proper through the distortion decision process, and therefore, a vector indicating the coordinates of the central point cₒ has a correct value to such an extent that the coordinates of the central point cₒ can be regarded as the offset q_{OFF} of the magnetic sensor.

Consequently, it is possible for a portable instrument 1 according to the first modification to obtain a rough direction and magnitude of geomagnetism B_{g} using the offset estimation value qₒ of the magnetic sensor calculated by the Kalman filter operation unit 120a until the central point derivation unit 200 calculates the coordinates of the central point cₒ. As a result, it is possible for the portable instrument 1 to display the direction and magnitude of the geomagnetism B_{g} without a user of the portable instrument 1 waiting for a long period of time, thereby improving convenience in use.

(2) Second Modification

Although, in the above-described embodiment, the central point derivation unit 200 performs the initialization process, the magnetic data accumulation process, the magnetic data distribution decision process, the central point calculation process, the distortion decision process, and the central point output process, the present invention is not limited thereto. The central point derivation unit may perform some of the above-mentioned processes. For example, upon performing the central point output process, the central point derivation unit 200 may output the coordinates of the central point cₒ calculated through the central point calculation process without performing the distortion decision process. Also, the central point derivation unit 200 may perform the central point calculation process without performing the magnetic data distribution decision process.

In this case, it is possible for the central point derivation unit 200 to easily calculate the value of the offset q_{OFF} of the magnetic sensor after change even in a case in which the offset q_{OFF} of the magnetic sensor is suddenly and greatly changed.

(3) Third Modification

Although, in the above-described embodiment, the Kalman filter operation unit 120 overwrites the components representing the offset estimation value qₒ of the magnetic sensor, which is one of the components of the state vector x, using the coordinates of the central point cₒ output from the central point derivation unit 200 through the delay unit 121, the present invention is not limited thereto. The Kalman filter operation unit may overwrite the state vector x using the coordinates of the central point cₒ through a unit other than the delay unit 121.

For example, upon generating 2a+1 sigma points, the sigma point generation unit 122 may overwrite the component representing the offset estimation value qₒ of the magnetic sensor, which is one of the components of the state vector x⁺ₖ after update present at the right side of equation (14) and equation (15), using the coordinates of the central point cₒ. Also, the state transition model used in operation of the state transition model unit 123 may overwrite the component representing the offset estimation value q_{O,K-1} of the magnetic sensor at the right side of equation (27) using the coordinates of the central point cₒ. Furthermore, the component representing the offset estimation value qₒ of the magnetic sensor, which is one of the components of the state vector x⁺ₖ after update, calculated by the adder 129 may be overwritten using the coordinates of the central point cₒ.

(4) Fourth Modification

Although, in the above-described embodiment, the Kalman filter operation unit 120 performs an operation using a sigma point Kalman filter, which is a nonlinear Kalman filter, the present invention is not limited thereto. The Kalman filter operation unit 120 may perform an operation using another nonlinear Kalman filter, such as an extended Kalman filter, in addition to the sigma point Kalman filter.

(5) Fifth Modification

Although, in the above-described embodiment, the posture p of the portable instrument 1, strength r of the geomagnetism, magnetic dip φ of the geomagnetism, angular velocity ω of the portable instrument 1, offset estimation value gₒ of the angular velocity sensor, and offset estimation value qₒ of the magnetic sensor are adopted as the components of the state vector x, and these six state variables are estimated through the Kalman filter operation, the present invention is not limited thereto. For example, the state vector x may be constituted by some of these six state variables, and some of these six state variables may be estimated.

(6) Sixth Modification

Although, in the above-described embodiment, the observation vector yₖ is a vector having an observed value q, which is an output of the magnetic sensor, an observed value a, which is an output of the acceleration sensor, and an observed value g, which is an output of the angular velocity sensor, as components, the present invention is not limited thereto. The observation vector may be generated using only some of the components.

What is claimed is:

1. A state estimation apparatus comprising:
a plurality of sensors including a three-dimensional magnetic sensor configured to detect magnetic components in three directions and configured to sequentially output magnetic data representing the detected magnetic components;
a Kalman filter configured to update a state vector based on an observation residual, the state vector having components representing a plurality of state variables which include a state variable for estimating an offset of the magnetic data, the observation residual being calculated using the state vector and an observation vector having components representing outputs of the plurality of sensors;
an accumulation unit configured to accumulate the magnetic data sequentially output from the three dimensional magnetic sensor; and
a central point calculation unit configured to assume that coordinates indicated by a predetermined number of the accumulated magnetic data probabilistically distribute in the vicinity of a first spherical surface, and configured to calculate coordinates indicating a central point of the first spherical surface, wherein
the Kalman filter updates the state variable for estimating an offset of the magnetic data using the coordinates indicating the central point of the first spherical surface.

2. The state estimation apparatus according to claim 1, wherein the Kalman filter is configured to use a state transition model for estimating a state vector after lapse of a unit time from a state vector at a certain time, configured to use an observation model for calculating an estimated observation vector from the estimated state vector after the lapse of the unit time, configured to calculate an observation residual based on the estimated observation vector and the observation vector having components representing outputs of the plurality of sensors, and configured to update the state vector based on the observation residual and the estimated state vector after the lapse of the unit time.

3. The state estimation apparatus according to claim 1, further comprising:
a distribution decision unit configured to calculate a dispersion evaluation value indicating a degree of three-dimensional dispersion in distribution of coordinates of the predetermined number of the accumulated magnetic data, so that the central point calculation unit is configured to calculate the coordinates indicating the central point of the first spherical surface in case that the dispersion evaluation value is equal to or greater than an allowable dispersion value;
a distortion decision unit configured to assume that the coordinates indicated by a plurality of the accumulated magnetic data are probabilistically distribute in the vicinity of a surface of a three-dimensional figure obtained by combining a second spherical surface and a curved surface, configured to calculate a distortion evaluation value indicating a degree of difference of a shape of the three-dimensional figure from a shape of the second spherical surface based on the plurality of the accumulated magnetic data, and configured to decide whether or not the distortion evaluation value is equal to or less than an allowable distortion value; and
a central point output unit configured to output the coordinates indicating the central point of the first spherical surface in case that a decision result of the distortion decision unit is affirmative.

4. The state estimation apparatus according to claim 3, wherein the Kalman filter is configured to update the state variable for estimating an offset using the coordinates indicating the central point of the first spherical surface in case that the central point output unit outputs the coordinates indicating the central point of the first spherical surface.

5. The state estimation apparatus according to claim 1, wherein the central point calculation unit is configured to assume that positions specified by the coordinates indicated by the magnetic data probabilistically distribute in the vicinity of the first spherical surface, configured to set first spherical error vectors representing errors between the positions specified by the coordinates indicated by the magnetic data and the first spherical surface, configured to set a central point calculation function which contains a three-dimensional vector as a variable, and which represents a magnitude of the first spherical error vectors, and configured to calculate the coordinates indicating the central point of the first spherical surface as coordinates indicated by the three-dimensional vector when a value of the central point calculation function is minimized.

6. The state estimation apparatus according to claim 1, wherein three three-dimensional magnetic sensor is mounted in an instrument comprising a part generating a magnetic field.

7. The state estimation apparatus according to claim 6, wherein the offset is a three-dimensional vector representing a component of the magnetic field generated by the part of the instrument.

8. An offset update method performed in a state estimation apparatus comprising a plurality of sensors including a three-dimensional magnetic sensor configured to detect magnetic components in three directions and configured to sequentially output magnetic data representing the detected magnetic components, the method comprising;
updating a state vector based on an observation residual, the state vector having components representing a plurality of state variables which include a state variable for estimating an offset of the magnetic data, the observation residue being calculated using the state vector and an observation vector having components representing outputs of the plurality of sensors;
accumulating the magnetic data sequentially output from the three dimensional magnetic sensor;
assuming that coordinates indicated by a predetermined number of the accumulated magnetic data probabilistically distribute in the vicinity of a first spherical surface;
calculating coordinates indicating a central point of the first spherical surface; and
updating the state variable for estimating an offset of the magnetic data using the coordinates indicating the central point of the first spherical surface.
